(19) United States
(12) Patent Application Publication
(10) Pub. No.: US 2026/0208857 A1
(43) Pub. Date: Jul. 23, 2026

(54) AERODYNAMIC DESIGN OF PROPELLER BLADES IN VTOL AIRCRAFT

(71) Applicant: Archer Aviation Inc., San Jose, CA (US)

(72) Inventors: Dario ISOLA, Mountain View, CA (US); Giovanni DROANDI, San Jose, CA (US); Spencer FUGAL, Reno, NV (US); Christopher M. HEATH, Avon, OH (US)

(73) Assignee: Archer Aviation Inc., San Jose, CA (US)

(21) Appl. No.: 19/571,415

(22) Filed: Mar. 18, 2026

Related U.S. Application Data
(63) Continuation of application No. PCT/US2024/060600, filed on Dec. 17, 2024.
(60) Provisional application No. 63/611,573, filed on Dec. 18, 2023.

(51) Int. Cl. B64C 27/48; B64C 27/467; B64C 29/00; B64D 31/00

(52) U.S. Cl. CPC B64C 27/48; B64C 27/467; B64C 29/0016; B64D 31/00

(57) ABSTRACT

A lift apparatus for a vertical takeoff and landing (VTOL) aircraft, the lift apparatus comprising: a lift propeller comprising a first blade, a second blade, a third blade, and a fourth blade; and a hub joining the first blade, the second blade, the third blade, and the fourth blade to form a continuous surface contour; wherein the first blade is adjacent to the second blade and to the third blade; and a first stagger angle between the first blade and the second blade is less than a second stagger angle between the first blade and the third blade; and wherein an elbow contour leading from the first blade to the third blade comprises a saddle point at the hub.

### TECHNICAL FIELD

The present application claims priority under 35 U.S.C. § 119 to U.S. Provisional Patent Application No. 63/611,573, filed Dec. 18, 2023, titled “Aerodynamic Design of Propeller Blades in VTOL Aircraft.” The entire contents of the aforementioned application are incorporated herein by reference for all purposes.

### TECHNICAL FIELD

This disclosure relates generally to the field of powered aerial vehicles. More particularly, and without limitation, the present disclosure relates to innovations in tilt-rotor aircraft that use electrical propulsion systems. Certain aspects of the present disclosure generally relate to apparatus and methods for lift propellers in vertical takeoff and landing (VTOL) aircraft.

### SUMMARY

Embodiments of the present disclosure provide a lift apparatus for a vertical takeoff and landing (VTOL) aircraft. The lift apparatus may comprise: a lift propeller comprising a plurality of blades configured to rotate about a rotational axis, each blade comprising a root chord and a blade tip. The root chord of each of the plurality of blades may be located at a distance from the rotational axis of between 15% and 25% of a radius of the blade. Each of the plurality of blades comprises a root taper ratio of 1 or less, wherein the root taper ratio is a ratio of a length of the root chord to an average chord length of the blade from the root chord to the blade tip.

Some embodiments of the present disclosure provide a lift apparatus for a vertical takeoff and landing (VTOL) aircraft. The lift apparatus may comprise: a lift propeller comprising a plurality of blades configured to rotate about a rotational axis, each blade comprising: a root chord; an inner intermediate chord; a middle chord; an outer intermediate chord; a tip chord; and a blade tip. The root chord of each of the plurality of blades may be located at a distance from the rotational axis of between 18% and 22% of a radius of the blade. The tip chord of each of the plurality of blades may be located at a distance from the rotational axis of between 90% and 100% of the radius of the blade. The middle chord may be located at a distance halfway between the root chord and the blade tip. The inner intermediate chord may be located at a distance halfway between the root chord and the middle chord. The outer intermediate chord is located at a distance halfway between the middle chord and the blade tip. A length of the tip chord may be greater than a length of the root chord. A length of the inner intermediate chord may be greater than a length of the tip chord. A length of the outer intermediate chord may be greater than a length of the inner intermediate chord. A length of the middle chord may be greater than a length of the outer intermediate chord.

Some embodiments of the present disclosure provide a lift apparatus for a vertical takeoff and landing (VTOL) aircraft. The lift apparatus may comprise: a lift propeller; an electric engine configured to rotate the lift propeller in a lift configuration and position the lift propeller at an angle with respect to a reference axis in a cruise configuration; and a support structure configured to support the electric engine and the lift propeller. The reference axis may comprise one of a longitudinal axis of the support structure or a longitudinal axis of a fuselage of the VTOL aircraft, and the angle may be from 2 to 20 degrees.

Some embodiments of the present disclosure provide a method of operating a vertical takeoff and landing (VTOL) aircraft. The method may comprise: rotating a lift propeller in a lift configuration; and positioning the lift propeller at an angle with respect to a longitudinal axis of a fuselage of the VTOL aircraft in a cruise configuration. The angle may be from 2 to 20 degrees.

### BRIEF DESCRIPTIONS OF FIGURES

FIG. 1A illustrates an example VTOL aircraft in a cruise configuration, consistent with embodiments of the present disclosure.

FIG. 1B illustrates an example VTOL aircraft in a lift configuration, consistent with embodiments of the present disclosure.

FIGS. 2A-2C illustrate example VTOL aircraft in a lift and cruise configurations, consistent with embodiments of the present disclosure.

FIG. 3 illustrates example blade chord sections in lift propellers of a VTOL aircraft, consistent with embodiments of the present disclosure.

FIG. 4 illustrates example hub frontal areas in lift propellers of a VTOL aircraft, consistent with embodiments of the present disclosure.

FIG. 5 illustrates a rotor solidity of a lift propeller, consistent with embodiments of the present disclosure.

FIGS. 6A-6C illustrate example lift propeller blade designs for a VTOL aircraft, consistent with embodiments of the present disclosure.

FIGS. 7A-7C illustrate example VTOL aircraft in clocked and un-clocked configurations, consistent with embodiments of the present disclosure.

FIGS. 8A-8B illustrate example lift propeller assemblies for a VTOL aircraft, according to a comparative embodiment.

FIGS. 9A-9C illustrate example VTOL aircraft propeller assembly, consistent with embodiments of the present disclosure.

FIGS. 10A-10C illustrate example VTOL aircraft propeller parameters of interest, consistent with embodiments of the present disclosure.

FIG. 11 is a flow diagram of an exemplary process of operating a lift propeller, consistent with embodiments of the present disclosure.

### DETAILED DESCRIPTION

The present disclosure addresses components of electric vertical takeoff and landing (eVTOL) aircraft primarily for use in a non-conventional aircraft. For example, the eVTOL aircraft of the present disclosure may be intended for frequent (e.g., over 50 flights per workday), short-duration flights (e.g., less than 100 miles per flight) over, into, and out of densely populated regions. The aircraft may be intended to carry 4-6 passengers or commuters who have an expectation of a low-noise and low-vibration experience. Accordingly, it may be desired that their components are configured and designed to withstand frequent use without wearing, that they generate less heat and vibration, and that the aircraft include mechanisms to effectively control and manage heat or vibration generated by the components. Further, it may be intended that several of these aircraft operate near each other over a crowded metropolitan area. Accordingly, it may be desired that their components are configured and designed to generate low levels of noise interior and exterior to the aircraft, and to have a variety of safety and backup mechanisms. For example, it may be desired for safety reasons that the aircraft are propelled by a distributed propulsion system, avoiding the risk of a single point of failure, and that they are capable of conventional takeoff and landing on a runway. Moreover, it may be desired that the aircraft can safely vertically takeoff and land from and into relatively restricted spaces (e.g., vertiports, parking lots, or driveways) compared to traditional airport runways while transporting around 4-6 passengers or commuters with accompanying baggage. These use requirements may place design constraints on aircraft size, weight, operating efficiency (e.g., drag, energy use), which may impact the design and configuration of the aircraft components.

Disclosed embodiments provide new and improved configurations of aircraft components that are not observed in conventional aircraft, and/or identified design criteria for components that differ from those of conventional aircraft. Such alternate configurations and design criteria, in combination addressing drawbacks and challenges with conventional components, yielded the embodiments disclosed herein for various configurations and designs of eVTOL aircraft components.

In some embodiments, the eVTOL aircraft of the present disclosure may be designed to be capable of both vertical and conventional takeoff and landing, with a distributed electrical propulsion system enabling vertical flight, forward flight, and transition. Thrust may be generated by supplying high voltage electrical power to the electrical engines of the distributed electrical propulsion system, which each may convert the high voltage electrical power into mechanical shaft power to rotate a propeller. Embodiments disclosed herein may involve optimizing the energy density of the electrical propulsion system. Embodiments may include an electrical engine connected to an onboard electrical power source, which may include a device capable of storing energy such as a battery or capacitor, or may include one or more systems for harnessing or generating electricity such as a fuel powered generator or solar panel array. Some disclosed embodiments provide for weight reduction and space reduction of components in the aircraft, thereby increasing aircraft efficiency and performance. Given focus on safety in passenger transportation, disclosed embodiments implement new and improved safety protocols and system redundancy in the case of a failure, to minimize any single points of failure in the aircraft propulsion system. Some disclosed embodiments also provide new and improved approaches to satisfying aviation and transportation laws and regulations.

In preferred embodiments, the distributed electrical propulsion system may include twelve electrical engines, which may be mounted on booms forward and aft of the main wings of the aircraft. The forward electrical engines may be tiltable mid-flight between a horizontally oriented position (e.g., to generate forward thrust) and a vertically oriented position (e.g., to generate vertical lift). The forward electrical engines may be of a clockwise type or counterclockwise type in terms of direction of propeller rotation. The aft electrical engines may be fixed in a vertically oriented position (e.g., to generate vertical lift). They may also be of a clockwise type or counterclockwise type in terms of direction of propeller rotation. In some embodiments, an aircraft may possess various combinations of forward and aft electrical engines. For example, an aircraft may possess six forward and six aft electrical engines, four forward and four aft electrical engines, or any other combination of forward and aft engines, including embodiments where the number of forward electrical engines and aft electrical engines are not equivalent. In some embodiments, an aircraft may possess four forward and four aft propellers, where at least four of these propellers comprise tiltable propellers.

In preferred embodiments, for a vertical takeoff and landing (VTOL) mission, the forward electrical engines as well as aft electrical engines may provide vertical thrust during takeoff and landing. During flight phases where the aircraft is in forward flight-mode, the forward electrical engines may provide horizontal thrust, while the propellers of the aft electrical engines may be stowed at a fixed position in order to minimize drag. The aft electrical engines may be actively stowed with position monitoring. Transition from vertical flight to horizontal flight and vice-versa may be accomplished via the tilt propeller subsystem. The tilt propeller subsystem may redirect thrust between a primarily vertical direction during vertical flight mode to a mostly horizontal direction during forward-flight mode. In some embodiments, the transition mode of flight may be utilized for more than a brief change between lift and cruise. For example, tilt propellers may be maintained at intermediate angles to generate thrust vectors that lie between substantially horizontal and substantially vertical, either in combination with operating the lift propellers or independently of them. This may allow the aircraft to travel at speeds well below the stall speed of a comparably sized conventional airplane, and to move seamlessly above and below such a speed without any disruption to the passenger experience. A variable pitch mechanism may change the forward electrical engine's propeller-hub assembly blade collective angles for operation during the hover-phase, transition phase, and cruise-phase.

In some embodiments, in a conventional takeoff and landing (CTOL) mission, the forward electrical engines may provide horizontal thrust for wing-borne take-off, cruise, and landing. In some embodiments, the aft electrical engines may not be used for generating thrust during a CTOL mission and the aft propellers may be stowed in place.

In some embodiments, an electric engine may be housed or connected to a boom of an aircraft and include a motor, inverter, and gearbox. In some embodiments, an electric engine may be housed or connected to another structural component of the aircraft, such as, e.g., a wing, tail, fuselage or other body. In some embodiments, the motor, inverter, and gearbox may be interfaced such that they share a central axis. In some embodiments, the torque originating in the motor may be transferred from the propellers of the propulsion system and to a gearbox. In some embodiments, a gearbox may provide a gear reduction and then send the torque, via a main shaft, back through a bearing located inside the motor and to the propeller. In some embodiments, an inverter may be mounted on the rear of a gearbox such that a main shaft does not travel through the inverter when outputting torque to the propeller. In some embodiments, the motor, gearbox, and inverter may be interfaced such that a coolant, such as oil, may be used to service the motor, inverter, and/or gearbox, while sharing a common heat exchanger. In some embodiments, the amount of oil used to lubricate and cool the electric engine may vary, including amounts less than one quart, two quarts, three quarts, or any other measured amount of oil.

In some embodiments, a tilt propeller system may include a linear or rotary actuator to change the orientation of a propulsion system during operation. In some embodiments, the pitch of the propulsion system may be changed as a function of the orientation of the propulsion system. In some embodiments, a rotary actuator may include a motor, inverter, and gearbox. In some embodiments, a gearbox may include various types of gears interfacing to provide a gear reduction capable of orienting the propulsion system. In some embodiments, a tilt propeller system may include a redundant configuration such that multiple motors, inverters, and gearboxes are present and interface using a gear. In some embodiments, a configuration utilizing multiple motors, gearboxes, and inverters may allow a failed portion of the redundant configuration to be driven by the motor, inverter, and gearbox of another portion of the configuration. In some embodiments, a gearbox configuration may also allow the tilt propeller system to maintain a propulsion system orientation with the help of, or without, additional power being provided by the system.

In some embodiments, an electrical propulsion system as described herein may generate thrust by supplying High Voltage (HV) electric power to an electric engine, which in turn converts HV power into mechanical shaft power which is used to rotate a propeller. As mentioned above, an aircraft as described herein may possess multiple electric engines which are boom-mounted forward and aft of the wing. The amount of thrust each electric engine generates may be governed by a torque command from the Flight Control System (FCS) over a digital communication interface to each electric engine. Embodiments may include forward electric engines that may be able to alter their orientation, or tilt. Additional embodiments include forward engines that may be a clockwise (CW) type or counterclockwise (CCW) type. The forward electric engine propulsion subsystem may consist of a multi-blade adjustable pitch propeller, as well as a variable pitch subsystem.

In some embodiments, an aircraft may include aft engines, or lifters, that may be of a clockwise (CW) type or counterclockwise (CCW) type. Additional embodiments may include aft electric engines that utilize a multi-blade fixed pitch propeller.

As described herein, the orientation and use of electric propulsion systems may change throughout the operation of the aircraft. In some embodiments, during vertical takeoff and landing, the forward propulsion systems as well as aft propulsion systems may provide vertical thrust during takeoff and landing. During the flight phases where the aircraft is in forward flight-mode, the forward propulsion systems may provide horizontal thrust, while the aft propulsion system propellers may be stowed at a fixed position in order to minimize drag. The aft electric propulsion systems may be actively stowed with position monitoring. Some embodiments may include a transition from vertical flight to horizontal flight and vice-versa. In some embodiments, the transitions may be accomplished via the tilt propeller system (TPS). The TPS may redirect thrust between a primarily vertical direction during vertical flight mode to a mostly horizontal direction during forward-flight mode. Additional embodiments may include a variable pitch mechanism that may change the forward propulsion system propeller-hub assembly blade collective angles for operation during the hover-phase, cruise-phase and transition phase. Some embodiments may include a Conventional Takeoff and Landing (CTOL) configurations such that the tilters provide horizontal thrust for wing-borne take-off, cruise and landing. The aft electronic engines are not used for generating thrust during a CTOL mission and the aft propellers are stowed in place.

As disclosed herein, an electrical engine may include an inverter and motor; or inverter, gearbox, and motor across various configurations, such as representative configurations as described herein. For example, an electrical engine may include an electrical motor, gearbox, and inverter that all share the same central axis. Additionally, the central axis may be configured along an axis of an output shaft going to the propeller of the aircraft. In such an exemplary configuration, the motor, gearbox, and inverter may all share the output shaft as a central axis and would be circularly oriented around the output shaft. Additional embodiments may include a motor, gearbox, and inverter that are mounted together in a sequence, or a configuration where some of the components are mounted together, such as the motor and gearbox, and another component is located elsewhere, such as the inverter, but wiring systems may be used to connect the electrical engine.

As mentioned above, an electrical engine for an aircraft as described here may include some or all of a motor, inverter, and gearbox. Various configurations may include an inverter and motor such that the output shaft of a motor directly provides the speed and torque for a propeller shaft. Additional embodiments of an electrical engine may include a motor, inverter, and a gearbox, wherein the output of a motor may travel through a gearbox that is connected to the output shaft for the propeller; a motor, inverter, and gearbox wherein the output from the motor travels away from the propeller, through a gearbox, where the output shaft for the propeller travels back through the gearbox and motor to the propeller. As described herein, an electrical engine may account for any combination or orientation of some or all of a motor, inverter, and gearbox. Additionally, each configuration or orientation of the electrical engine as disclosed herein may include cooling via air-cooling, coolant liquid, or a mixture of both.

For example, a configuration of an electrical engine may include a motor and inverter wherein the motor is in between the propeller of the aircraft and the inverter. Additionally, a motor may include a gearbox. Further, an inverter may share the same central axis as a motor wherein the inverter may be located in an enclosure that is cantilevered off of the rear of the motor and may be air cooled. It is recognized that such an inverter orientation may not be an optimum configuration in terms of the enclosure required to achieve such a cantilevered orientation. Additionally, a motor in this configuration utilizing air cooling may comprise potting material and air fins to assist with cooling of the motor may lead to an even larger increase in mass of the system.

Some embodiments may include an electrical engine, wherein inverter modules may be mounted on the outside of a motor enclosure. Additional embodiments may include an electrical engine wherein an inverter may be mounted on top of an electrical motor such that the air-cooling fins of the inverter are underneath the propeller. Further embodiments may include an inverter mounted to the back of a motor with air-cooling fins facing out radially, an inverter mounted to the front of a motor with the air-cooling fins facing out radially, an inverter mounted to a motor where the inverter is cooled by a liquid, such as oil, or any other position of the inverter relative to a motor.

Embodiments of an electrical motor may comprise a stator enclosure, a wound stator assembly, a rotor, various bearings, and any additional components such that to assist in transferring the speed and torque generated by the motor to a propeller.

It is understood that an electrical engine may generate heat during operation and may comprise a heat management system to ensure components of the electrical engine do not fail during operation. In some embodiments, coolant may be used and circulated throughout individual components of the engine, such as an inverter, gearbox, or motor, through some of the components, or through all of the components of the engine to assist with managing the heat present in the engine. Additional embodiments may include using air cooling methods to cool the electrical engine or using a mixture of coolant and air to manage the heat generated during operation in the electrical engine. In some embodiments, the coolant being used may also be the same liquid that is being used as lubricant throughout the inverter, gearbox, or motor. For example, the inverter, gearbox, and motor may be cooled using a liquid or air, or a mixture of air and liquid cooling could be used, such as cooling the motor using air cooling and using liquid cooling in the inverter and gearbox, or any other combination of air and liquid cooling across the inverter, gearbox, and motor or even subsets of those components.

In some embodiments, oil may be used as a lubricant throughout an electrical engine and may also be used as coolant fluid to assist in managing the heat generated by the engine during operation. Further to this example, different amounts of oil may be used to act as both lubricant and coolant fluid in the electrical engine, such as less than one quart, less than two quarts, or any other amount of oil needed to lubricate and cool the electrical engine, in combination with or without the assistance of air cooling. As has been disclosed herein, an electrical engine may have different primary functionalities such as being used only for lifting and landing, and as such only being used in one orientation, or being used during all stages of flight such as lifting, landing, and in-flight. An engine that is used in all stages of flight may experience various orientations throughout flight and may comprise more lubricant and coolant than the engine only used in one orientation. As such, all the engines on an aircraft may not include the same amount of lubricant and coolant. For example, a lifting and landing engine may only require less than one quart of oil while an engine that operates in all stages of flight may require more than one quart of oil. It should be understood that the example embodiments as mentioned herein are representative and do not dictate the bounds of the amount of lubricant and coolant that may be used in an electrical engine.

It is understood that by using oil to not only lubricate the electrical engine but also cool the electrical engine rather than another coolant, additional oil will be added to the system, but that oil will remove traditional components that may be used to cool such an electrical engine. For example, if the electrical engine were cooled by another liquid such as glycol, the engine may comprise separate heat exchangers for both the lubricant fluid and the coolant fluid. As such, in embodiments where a single fluid is being used for both lubrication and cooling, such as oil, an increased amount of oil may be present but there may only be a need for one heat exchanger, so there may be a decrease in mass, due to use of fewer exchangers and potentially other components not being required, of the overall system and a more appealing drag profile may be present. Further, using one substance for the lubrication and cooling of the engine may increase efficiency of the system due to the reduction in mass and the benefits of cooling the engine with a substance rather than relying on air cooling which may have issues traveling throughout the engine.

The emergence of lift-plus-cruise type VTOL aircraft presents new aerodynamic challenges that may not be an issue in conventional aircraft. For instance, lift propellers may operate in two distinct flight configurations with very different design needs. In a lift configuration, the lift propeller may be spinning to generate vertical thrust for takeoff, landing, hovering, or transitional modes of flight. In such cases, it is important for the propeller to be capable of generating relatively large thrust within a relatively small volume while producing little noise. However, VTOL aircraft may also operate in a horizontal flight mode, or cruise configuration, in which the VTOL aircraft relies on wing borne flight in a manner that is similar to a conventional airplane. In the cruise configuration, the lift propeller may be stowed in a stationary position to minimize drag. In this configuration, it may be desirable for the blades to have a small forward-facing surface area, a low profile, and smooth, streamlined contours.

Embodiments of the present disclosure may provide lift propeller designs that are configured to balance the competing needs of the lift and cruise configurations. For example, some embodiments of the present disclosure are directed to a lift propeller blade profile. The lift propeller blade profile may be characterized by a root taper ratio. The root taper ratio may comprise a ratio of the chord length at the root to an average chord length over the blade. In some embodiments, the root chord may be defined at a nominal distance from a center of the hub.

In some embodiments, a lift propeller blade profile design may be characterized by a series of chord lengths and the relationships between them. For example, in some embodiments a lift propeller blade profile design may be characterized by the lengths of a root chord, an inner intermediate chord, a middle chord, an outer intermediate chord, or a tip chord. In some embodiments, a lift propeller blade profile design may be characterized by a root max ratio. The root max ratio may comprise a ratio of the root chord length to the maximum chord length of the blade.

In some embodiments, lift propeller blades may be stowed at a clocked angle in the cruise configuration. For example, the lift propeller blades may be stowed while operating the VTOL aircraft in forward flight in a cruise configuration such that a longitudinal axis of the lift propeller blade is offset from a reference axis of the VTOL aircraft by a predetermined angle. In some embodiments, the predetermined angle may be in a direction of rotation of the lift propeller. In some embodiments, the predetermined angle may comprise, e.g., between about 2 and 20 degrees. It is to be understood that terms like about, generally, or substantially should be interpreted to encompass commonly known design, machining, and manufacturing tolerances. Thus, for example, and angle of 20 degrees may encompass angles ranging between 20+5 degrees.

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the subject matter recited in the appended claims.

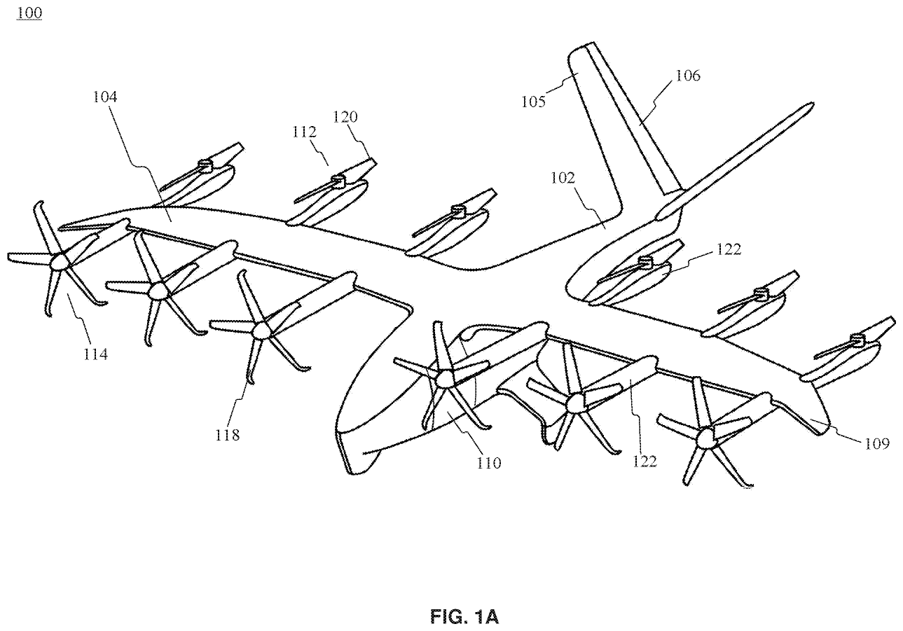

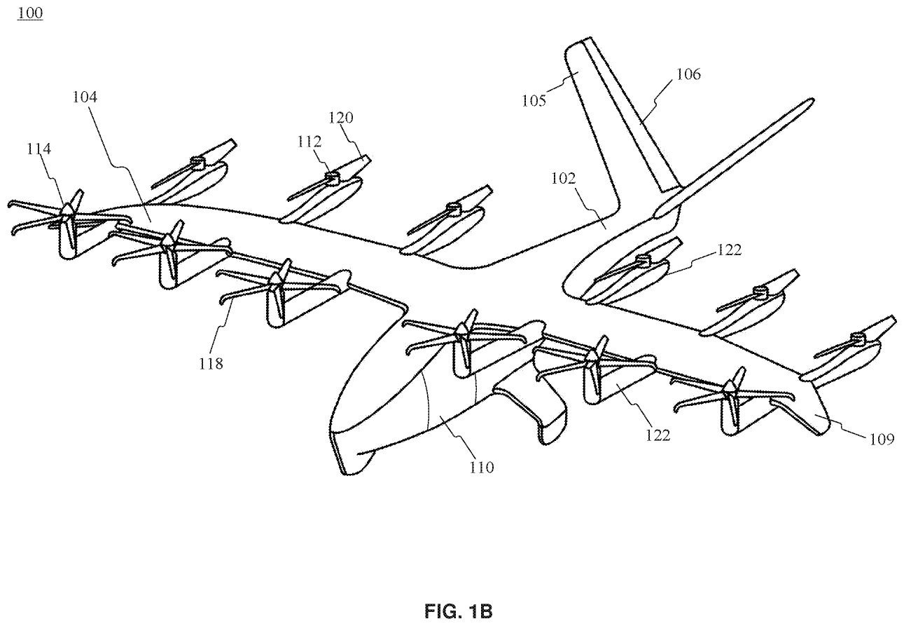

FIGS. 1A and 1B illustrate a VTOL aircraft 100 in a cruise configuration and a vertical take-off, landing and hover configuration (also referred to herein as a “lift” configuration), respectively, consistent with embodiments of the present disclosure. The aircraft 100 may include a fuselage 102, wings 104 mounted to the fuselage 102, tail 105, and one or more rear stabilizers 106 mounted to the tail 105 or the rear of the fuselage 102. A plurality of lift propellers 112 may be mounted to wings 104 and configured to provide lift for vertical take-off, landing and hover. A plurality of tilt propellers 114 may be mounted to wings 104 and may be tiltable between the cruise configuration in which they provide forward thrust to aircraft 100 for horizontal flight, as shown in FIG. 1A, and the lift configuration in which they provide a portion of the lift required for vertical take-off, landing and hovering, as shown in FIG. 1B. As used herein, a lift configuration may refer to a tilt propeller orientation in which the tilt propeller thrust is providing primarily lift to the aircraft. A cruise configuration may refer to a tilt propeller orientation in which the tilt propeller thrust is providing primarily forward thrust to the aircraft. Alternatively, a cruise configuration may refer to a configuration in which a lift propeller is stowed.

In some embodiments, lift propellers 112 may be configured for providing lift only, with all propulsion being provided by the tilt propellers. Accordingly, lift propellers 112 may be in fixed positions and may only generate thrust during take-off, landing and hover. Meanwhile, tilt propellers 114 may be tilted to lift configurations in which their thrust is directed vertically for providing additional lift.

For forward flight, tilt propellers 114 may tilt from their lift configurations to their cruise configurations. In other words, the pitch and tilt angle of tilt propellers 114 may be varied from an orientation in which the tilt propeller thrust is directed vertically (to provide lift during vertical take-off, landing and hover) to an orientation in which the tilt propeller thrust is directed horizontally (to provide forward thrust to aircraft 100). The tilt propellers may tilt about axes that may be generally perpendicular to the forward direction of the aircraft 100. When the aircraft 100 is in full forward flight during the cruise configuration, lift may be provided entirely by wings 104. Meanwhile, lift propellers 112 may be shut off. The blades 120 of lift propellers 112 may be locked in low-drag positions for aircraft cruising. In some embodiments, lift propellers 112 may each have two blades 120 that may be locked for cruising in minimum drag positions in which one blade is directly in front of the other blade as illustrated in FIG. 1A. In some embodiments, lift propellers 112 have more than two blades. In some embodiments, tilt propellers 114 include more blades 118 than lift propellers 112. For example, as illustrated in FIGS. 1A and 1B, lift propellers 112 may each include, e.g., two blades and tilt propellers 114 may each include, e.g., five blades. In some embodiments, tilt propellers 114 may have, e.g., from 2 to 5 blades.

In some embodiments, the aircraft may include only one wing 104 on each side of fuselage 102 (or a single wing that extends across the entire aircraft) and at least a portion of lift propellers 112 may be located rearward of wings 104 and at least a portion of tilt propellers 114 may be located forward of wings 104. In some embodiments, all of lift propellers 112 may be located rearward of wings 104 and all of tilt propellers 114 may be located forward of wings 104. According to some embodiments, all lift propellers 112 and tilt propellers 114 may be mounted to the wings—i.e., no lift propellers or tilt propellers may be mounted to the fuselage. In some embodiments, lift propellers 112 may be all located rearwardly of wings 104 and tilt propellers 114 may be all located forward of wings 104. According to some embodiments, all lift propellers 112 and tilt propellers 114 may be positioned inwardly of the wing tips 109.

In some embodiments, lift propellers 112 and tilt propellers 114 may be mounted to wings 104 by booms 122. Booms 122 may be mounted beneath wings 104, on top of the wings, and/or may be integrated into the wing profile. In some embodiments, one lift propeller 112 and one tilt propeller 114 may be mounted to each boom 122. Lift propeller 112 may be mounted at a rear end of boom 122 and tilt propeller 114 may be mounted at a front end of boom 122. In some embodiments, lift propeller 112 may be mounted in a fixed position on boom 122. In some embodiments, tilt propeller 114 may mounted to a front end of boom 122 via a hinge. Tilt propeller 114 may be mounted to boom 122 such that tilt propeller 114 is aligned with the body of boom 122 when in the cruise configuration, forming a continuous extension of the front end of boom 122 that minimizes drag for forward flight.

In some embodiments, aircraft 100 may include, e.g., one wing on each side of fuselage 102 or a single wing that extends across the aircraft. According to some embodiments, the at least one wing 104 is a high wing mounted to an upper side of fuselage 102. According to some embodiments, the wings include control surfaces, such as flaps, ailerons or flaperons. According to some embodiments, the wings may have curved wing tips 109 for reduced drag during forward flight.

In some embodiments, rear stabilizers 106 include control surfaces, such as one or more rudders, one or more elevators, and/or one or more combined rudder-elevators. The wing(s) may have any suitable design. For example, the wings have a tapering leading edge or a tapering trailing edge. In some embodiments, the wings may have a substantially straight leading edge in the central section of wings 104.

Aircraft 100 may include at least one door 110 for passenger entry and exit. In some embodiments, the door 110 may be located beneath and forward of wings 104 as seen in FIGS. 1A and 1B.

Further discussion of VTOL aircraft may be found in U.S. Patent Publication No. 2021/0362849, which is incorporated by reference in its entirety.

As discussed above, the design of VTOL lift propellers may require considerations that do not apply to conventional propeller-driven aircraft. For example, in a conventional propeller-driven aircraft, propellers may be spinning during all normal flight modes. Therefore the edge-wise airflow over a stowed vertically-facing propeller may not be a major design consideration. However, in VTOL aircraft, a lift propeller may be stationary during wing borne flight in the cruise configuration.

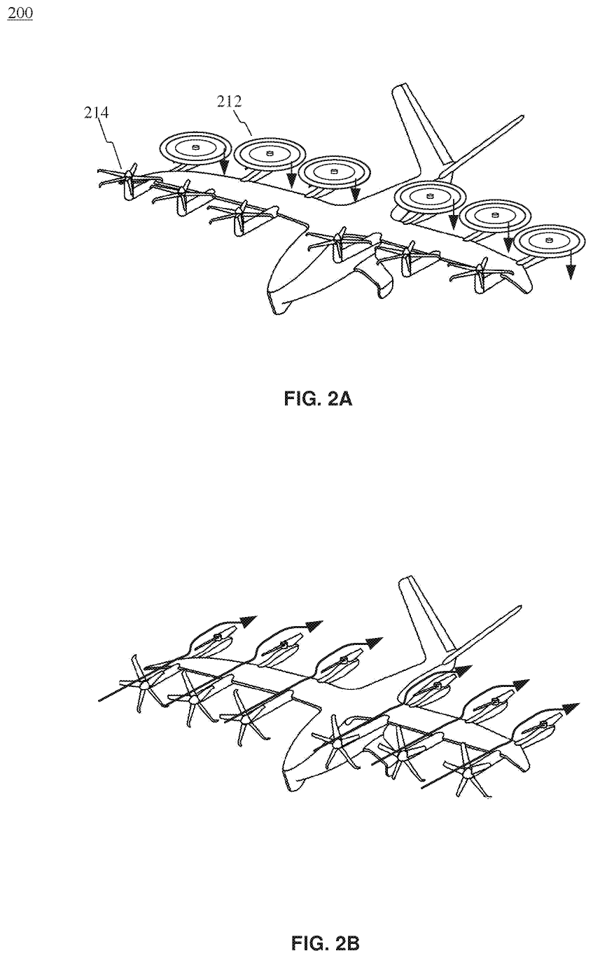

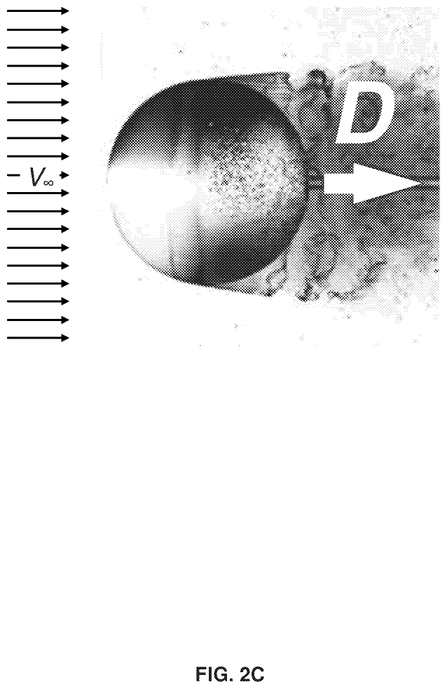

FIGS. 2A-2C illustrate an example VTOL aircraft 200 in the lift and cruise configurations, consistent with embodiments of the present disclosure. VTOL aircraft 200 may be, e.g., similar to VTOL aircraft 100 of FIGS. 1A and 1B. As seen in the lift configuration of FIG. 2A, lift propellers 212 must produce a high downward airflow to generate sufficient thrust for takeoff, landing and hover (while not shown in the Figures, tilt propellers 214 may also be generating lift). However, in an urban air mobility environment, it may be necessary to minimize noise generation as well. For example, it may be desirable to operate the lift propellers at a relatively low revolutions per minute (RPM) such that a tip Mach number remains below, e.g., 0.7, 0.6, 0.5 or 0.4. Thus, the lift propeller design requirements may call for a low aspect ratio blade having a large area to deliver sufficient power while remaining below a prescribed noise threshold. However, as illustrated in FIG. 2B, the cruise configuration requires a blade design that minimizes drag in the stowed position. Therefore it may be desirable in the cruise configuration to have a blade with a high aspect ratio, narrow blade tip, and low height profile. A blade aspect ratio may be a ratio of, e.g., the blade radius to a nominal chord length, such as the root chord length. The cumulative drag penalties associated with a plurality of lift propellers 212 can be significant. For example, excrescence drag around a hub, under or around a blade tip, or over another surface of the lift propeller, may degrade fuel efficiency and shorten the maximum flight range of a VTOL aircraft. Excrescence drag may refer to the drag created by the addition of protrusions on an otherwise streamlined surface.

The competing factors of high lift power and low drag are illustrated at FIG. 2C, which shows an example spherical blunt object in the presence of a fluid medium that is moving to the right with respect to the object. For example, the drag power P_{∞} of a blunt body may be represented by:

$${P}_{∞} = ρ {A}_{∞} {c}_{D} {V}_{∞}^{3} \qquad ( eqn . 1 )$$

where ρ represents the density of air, A_{∞} represents the frontal area of the body (e.g., a 2-dimensional projection of the 3-dimensional area “seen” by the oncoming air), and c_{D} represents a drag coefficient (a non-dimensional number that depends on the specific shape of the body as opposed to its size). Looking on the right side of eqn. 1, it is seen that frontal area of a propeller should be minimized to reduce drag. Meanwhile, the ideal power Pₕ achieved by a lift propeller in hover may be represented by:

$${P}_{h} = {N}_{b} {A}_{b} \sqrt{σ \frac{B {L}^{3}}{2 ρ}} \qquad ( eqn . 2 )$$

Where N_{b} represents the number of blades (two in the illustrated configurations), A_{b} represents the blade area, σ represents a rotor solidity (a ratio of the blade area to the total area of a circle swept out by the blades), BL represents a blade loading (thrust per unit area of the blades), and ρ represents the density of air. Here, power in hover may be increased by increasing the blade area, rotor solidity, and blade loading. The number of blades may also be increased, but it may come with an increased drag penalty, or in the case of folding blades, with higher levels of cost, complexity and increased failure points.

Combining eqn.'s 1 and 2 yields a power ratio Pₕ/P_{∞}0 represented by:

$$\frac{{P}_{h}}{{P}_{∞}} = \frac{{N}_{b}}{\frac{1}{2} ρ {c}_{D} {V}_{∞}^{3}} \frac{{A}_{b}}{{A}_{∞}} \sqrt{σ \frac{B {L}^{3}}{2 ρ}} = \frac{2 {N}_{b}^{2}}{{c}_{D} sin 2 θ \sqrt{π}} \frac{\sqrt{A R}}{{V}_{∞}^{3} T {R}^{2}} {( BL / ρ )}^{3 / 2} \qquad ( eqn . 3 )$$

Eqn. 3 may represent an estimated power ratio between power required to achieve hover by a lift propeller and the power required to overcome the drag created by the stowed propeller in cruise. The first term in this equation is a dimensionless number that is independent of propeller size. Taking example values such as, e.g., a drag coefficient of 0.5, a be flight speed of 60 m/s and a pitch angle at the root section of a blade as 30°, the first term may take a value of approximately 10.42, yielding

$$10.42 \frac{\sqrt{A R}}{T {R}^{2}} \frac{B {L}_{*}^{3 / 2}}{{V}_{∞}^{3}} \qquad ( eqn . 4 )$$

where BL*=BL/ρ. Embodiments of the present disclosure provide apparatus and methods for optimizing this ratio by mitigating drag in the cruise configuration while maintaining high thrust and low noise in the lift configuration.

### A. Example Lift Propeller Profile Embodiments

Some embodiments of the present disclosure provide a propeller blade design configured to balance the competing needs of the lift and cruise configurations. Various design considerations of a lift propeller are discussed in this section.

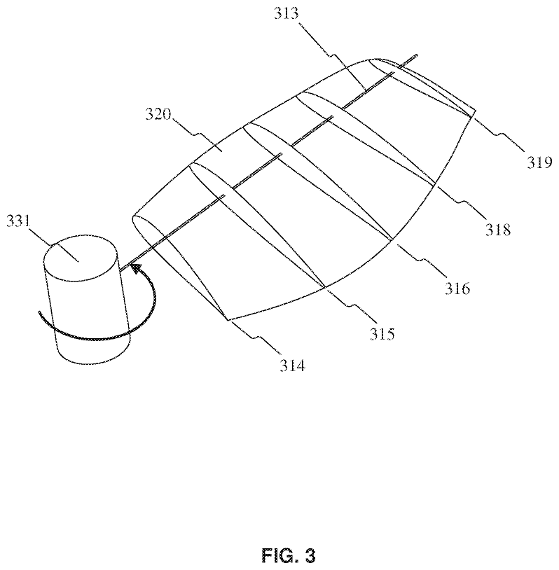

FIG. 3 illustrates portions of a lift apparatus of a VTOL aircraft, consistent with embodiments of the present disclosure. In FIG. 3, a lift propeller blade 320 and hub 331 are schematically illustrated in along with a plurality of chord sections 314-319. A chord section may comprise a cross-sectional area in a plane perpendicular to the blade axis 313 and having a propeller blade chord, wherein the chord may be a line that runs substantially perpendicular to the blade axis 313 from the leading edge to the trailing edge of a propeller blade as understood by persons having ordinary skill in the art. According to some disclosed embodiments, the various chord lengths along a blade may succinctly characterize important parameters for lifter blade geometry in VTOL aircraft. For example, various chord sections may be correlated to a rotor solidity, a propeller hub aspect ratio, a hub frontal area, a blade twist, and/or other design parameters. Because it is not always clear precisely where a propeller hub ends and a blade root begins, in some embodiments a root section may be defined at a nominal position of the blade/hub system. For example, in some exemplary embodiments a root section may be defined as the chord section located at about 20% of the distance from the rotational axis at the center of a hub to the tip of a propeller blade. In some embodiments, the root section may be taken as any section within a prescribed range of this distance, such as, e.g., between 15% and 25% of the distance from the rotational axis at the center of a hub to the tip of a propeller blade.

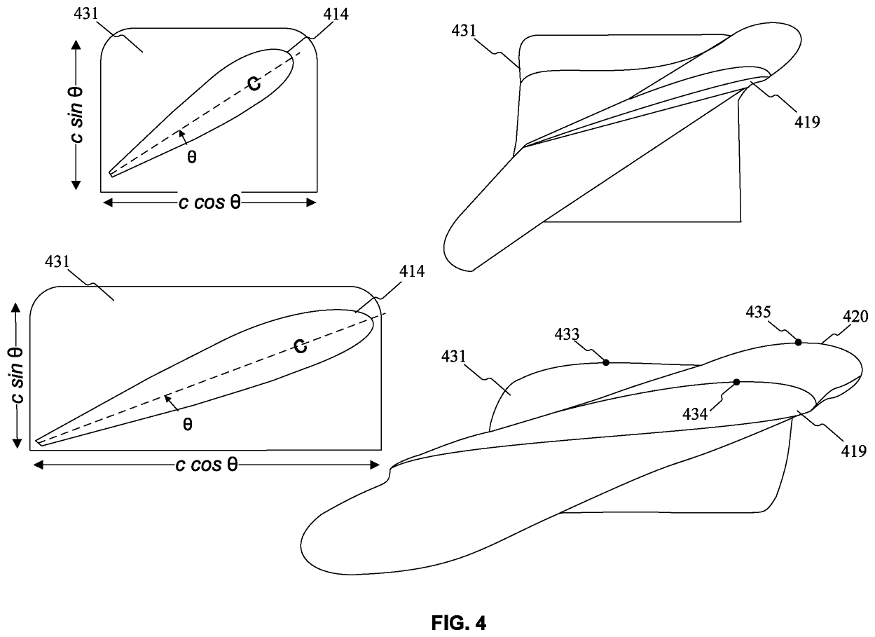

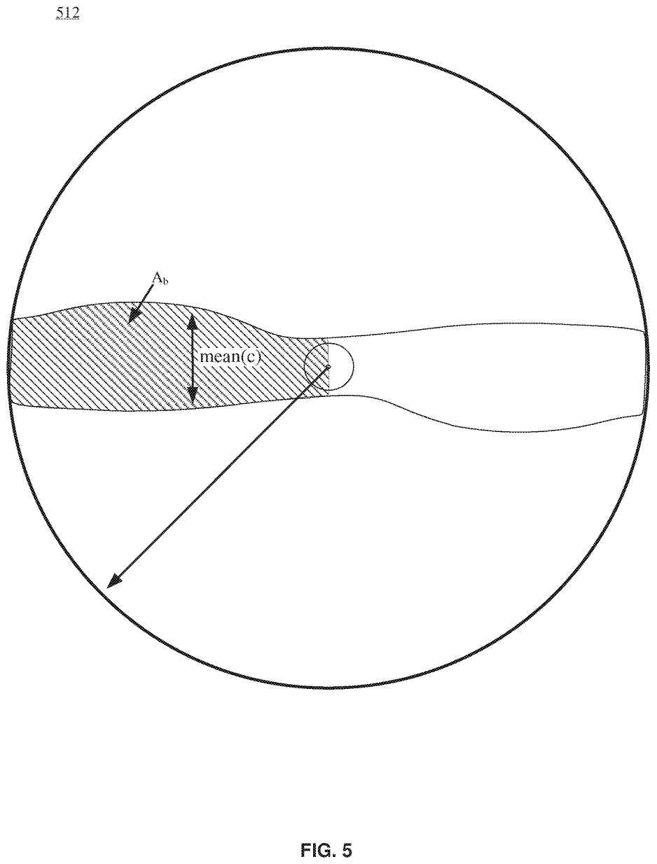

FIG. 4 illustrates a hub frontal area (the two-dimensional forward-facing area) and hub aspect ratio (a ratio of hub diameter to height) for two different configurations of a lift propeller, consistent with embodiments of the present disclosure. The frontal area of a hub 431 may relate to the amount of drag produced by a lift propeller in cruise, and further may relate to the chord length and pitch angle of blade 420 at the root section 414. The hub frontal area Ax may be estimated as

$${A}_{∞} = \frac{{c}_{R}}{2} sin 2 θ \qquad ( eqn . 5 )$$

where c_{R} represents the chord length at a nominally chosen root section 414 of the blade, and θ represents a pitch angle of the blade 420 at the root section 414. Further, the relationship of hub frontal area A_{∞} to blade area A_{b} can be represented in chord lengths by

$$\frac{{A}_{∞}}{{A}_{b}} = \frac{π}{{N}_{b}} \frac{σ}{2} T {R}^{2} sin 2 θ \qquad ( eqn . 6 )$$

where A_{b} represents the blade area, σ represents a rotor solidity, θ represents a pitch angle of the blade 420 at the root section 414, and TR represents a root taper ratio. The root taper ratio may comprise a ratio of the chord length c_{R} at the nominal root section to the average chord length cₘₑₐₙ of the blade, from the nominal root section to the tip. As seen in eqn. 6, a low root taper ratio TR is correlated to a low ratio of hub frontal area to blade area. This may be desirable in a lift propeller for VTOL aircraft, as a small frontal area may reduce drag, while a large blade area may beneficially produce large thrust for a small noise penalty. Note that, due to a difference in pitch angle of the top and bottom blade tips 419, a blade twist between the two different configurations may be approximately the same. Blade twist may relate to the change in blade pitch angle along the length of the blade, and it may serve to more evenly distribute the loads experienced by the propeller blade. In consideration of the various factors given above, the propeller shown at the bottom of FIG. 4 may have a more optimal design for use as a lift propeller in VTOL aircraft by balancing the VTOL-specific needs of high power in the lift configuration with low drag in the cruise configuration.

In some embodiments, a low profile of the hub 431 may be characterized by its height in relation to, e.g., propeller blade 420. For example, hub 431 may comprise a maximum height at a point 433, a blade tip 419 may comprise a maximum height at a point 434, and a blade 420 may comprise a maximum height at a point 435. The height may be characterized as a distance, in a direction parallel to the propeller rotation axis, from a reference point on the propeller apparatus such as, e.g., a propeller flange. In some embodiments, the maximum height of the hub 431 at point 433 may be not more than a predetermined distance above another point, such as the maximum height of blade tip 419 at point 434 or the maximum height of blade 420 at point 435. In some embodiments, the predetermined distance may be characterized in absolute terms and may comprise, e.g., 2 cm, 5 cm, or 10 cm. In some embodiments, the predetermined distance may be characterized in relative terms, such as a portion of a radius of the propeller blade. For example, in some embodiments, the predetermined distance may comprise, e.g., 1%, 2%, 5%, or 10% of the propeller blade radius. In some embodiments, the maximum height of blade 420 at point 435 may be above the maximum height of the hub 431 at point 433, and the maximum height of blade tip 419 at point 434 may be below the maximum height of the hub 431 at point 433.

FIG. 5 illustrates a rotor solidity o of a lift propeller 512, consistent with embodiments of the present disclosure. As discussed above, rotor solidity may be defined as a ratio of the blade area to the total area of a circle swept out by the blades:

$$σ = \frac{{N}_{b} {A}_{b}}{{A}_{c}} = \frac{{N}_{b} mean ( c )}{{R}_{c} π} = \frac{{N}_{b}}{A R π} \qquad ( eqn . 6 )$$

where R_{c} represents the circle radius, A_{c} represents the circle area, N_{b} represents the number of blades, A_{b} represents the blade area, mean (c) represents an average chord length of the blade, and AR represents the aspect ratio of the blades. According to eqn.'s 2 and 3 above, a high rotor solidity is beneficial for high hover power Pₕ and thus a high power ratio Pₕ/P_{∞}.

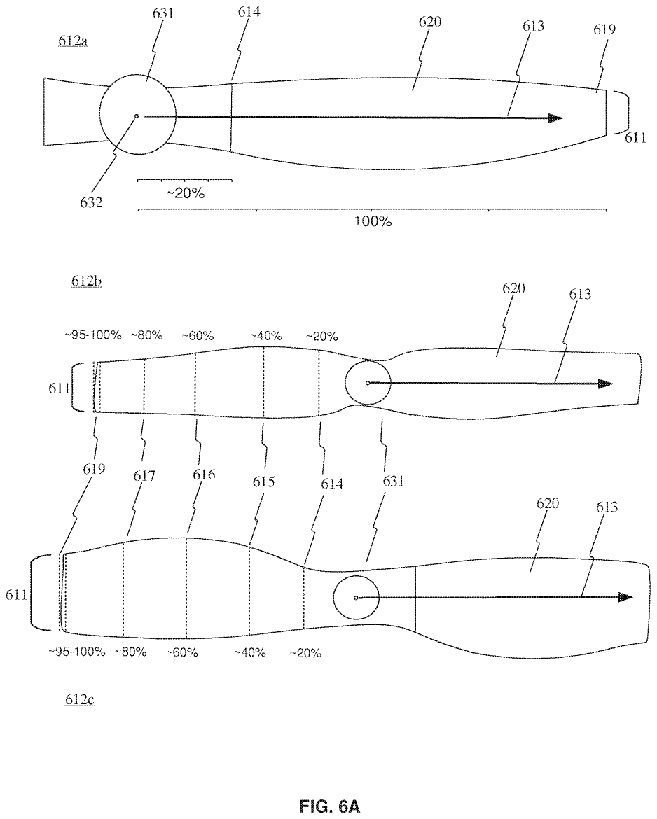

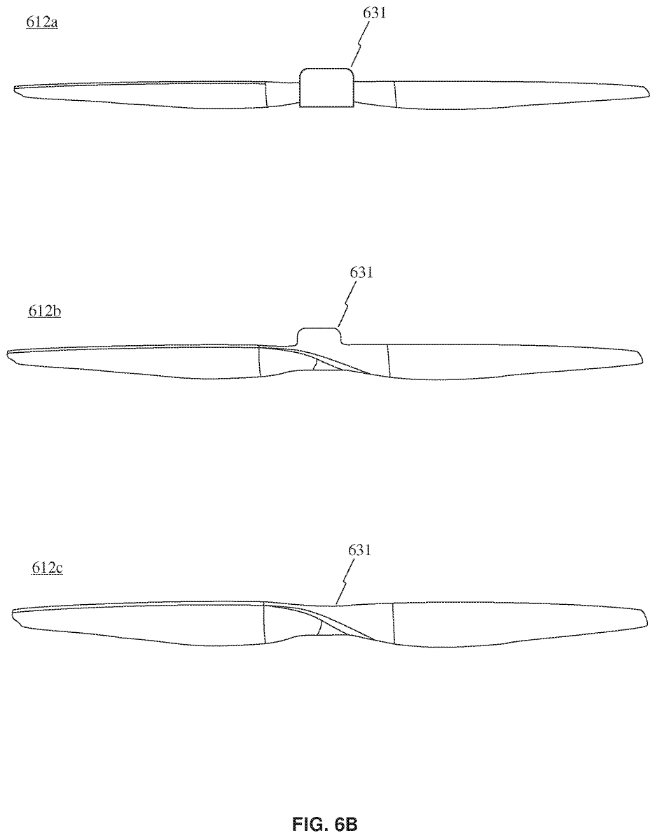

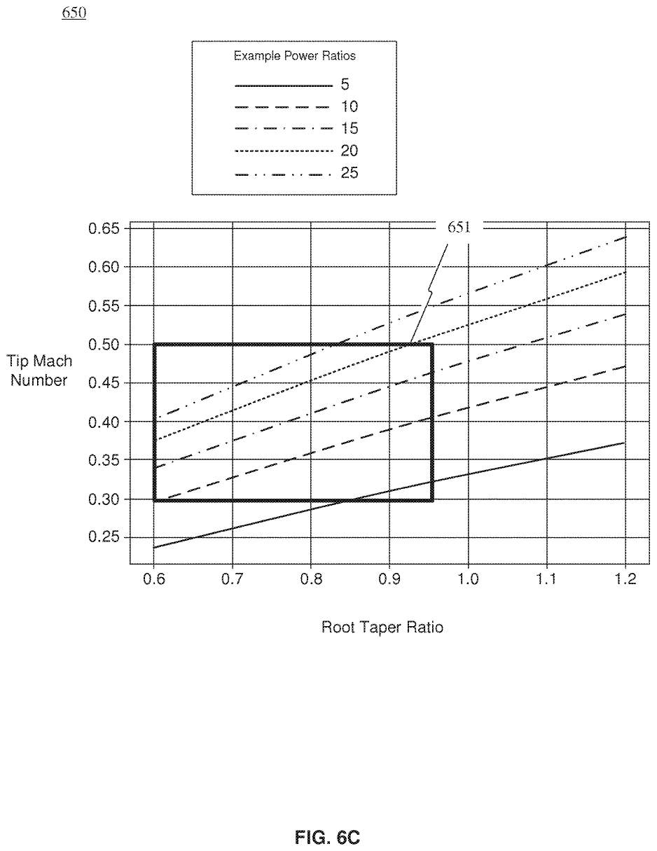

In view of the parameters above and their correlations to various chord lengths and other geometric parameters of a lift propeller, in some embodiments a lift propeller blade design may be characterized in terms of chord length parameters. FIGS. 6A-6C schematically illustrate this concept with respect to example embodiments of lift propellers 612a, 612b, and 612c for use in VTOL aircraft, consistent with embodiments of the present disclosure. In some embodiments a lift propeller may comprise a hub or blade design in which it is difficult to determine a clear, definitive boundary between a hub 631 and a blade 614. For example, in some embodiments a hub 631 may comprise a blended design in which its outer mold line blends continuously into the outer mold line of a blade 620. In other cases, the hub 631 may comprise a discrete design having a more distinct shape, such that a discontinuity between hub 631 and blade 620 are clearly visible. In the latter case, it may be easy to discern the precise location at which a hub 631 ends and a blade 620 begins. But in the former, it may be more difficult. For this reason, a nominal root chord location may be defined with respect to a clearly identifiable location, such as a rotation axis 632 (also referred to as a hub center) of a propeller 612 (such as one of propellers 612a, 612b, or 612c), as further discussed below. In some cases, the demarcation between blade and hub may be easily determined. For example, a hub may comprise the main structural support of the propeller, while the blade may comprise the primarily aerodynamic portion. Therefore in some embodiments a root chord length may be the length of the blade chord at the demarcation between the structural aerodynamic portions of the propeller.

The three propellers 612a-612c shown in FIG. 6A illustrate examples of various hub designs. For example, a propeller 612a at the top of FIG. 6A may comprise a discrete design (a design in which the blade and hub comprise recognizably distinct components). A propeller 612c at the bottom of FIG. 6A may comprise a blended design (a design in which the blade and hub appear as a single continuous surface), and the propeller 612b in the middle of FIG. 6 may represent a design that lies between these two extremes. For example, propeller 612b may comprise a semi-blended design in which a portion of hub 631 is substantially blended in a radial direction of blades 620, but protrudes in a direction of the propeller rotational axis. This is illustrated in the side views of propellers 612a-612c in FIG. 6B, showing a discrete hub design in propeller 612a, a partially blended hub design in propeller 612b, and a fully blended design in propeller 612c. A fully blended design may reduce drag and streamline the propeller outer mold line, which beneficially reduce drag in VTOL lift propellers when stowed in the cruise configuration.

A root chord 614 may be defined by its radial distance from hub center 632 along a longitudinal axis 613 of blade 620. In some embodiments, the distance may comprise a percentage of the total propeller radius, where the propeller radius is taken as a distance from the hub center 632 to a tip of blade 620. For instance, in some embodiments, the root chord 614 may be defined at a distance of, e.g., 20% of the propeller radius from a hub center 632. In some embodiments, the root chord 614 may be defined at a distance of, e.g., 10%, 15%, 20%, or 25% of the propeller radius. In some embodiments, the root chord 614 may be defined as lying within a range of distances, such as, e.g., between 15% and 25% of the propeller radius.

In some embodiments, a lift propeller may be designed with a root taper ratio of 1.0 or less, such as 0.8 or less, 0.7 or less, 0.6 or less, or 0.5 or less. As discussed above, the root taper ratio TR may comprise a ratio of the root chord length c_{R} to an average chord length mean (c) of the propeller blades, as:

$$T R = \frac{{c}_{R}}{mean ( c )} \qquad ( eqn . 7 )$$

where the average chord length mean (c) may comprise the average of all chord lengths from the root chord 614 to a tip 611 of blade 620. According to some disclosed embodiments, the root taper ratio TR may capture a large number of design parameters that are relevant to the two primary flight modes of VTOL aircraft (lift configuration and cruise configuration), such as the various design parameters and equations discussed above.

A propeller blade design may further be characterized by additional chord lengths and the relationships between them to define the general blade contour. For example, a propeller 612 (such as, e.g., 612b or 612c) may be characterized by the lengths of a root chord 614, an inner intermediate chord 615, a middle chord 616, an outer intermediate chord 617, or a tip chord 619. Similar to the root chord 614, the locations of these additional chords 615-619 may be defined at a nominal distance from a hub center 632, a range of distances from the hub center 632, or with respect to each other. Further, a propeller blade 612 (such as, e.g., 612a-c) may be asymmetric about its longitudinal axes 613.

For example, because some blade tips may taper to a fine point, there may be some uncertainty as to how to a definition a location, and therefore a length, of tip chord 619. Therefore in some embodiments, a tip chord 619 may be defined as being located within a prescribed range of tip 611, such as within 5% of the propeller radius from the tip 611. Stated another way, in some embodiments the tip chord 619 may be taken at a distance from, e.g., 90% to 100% or 95% to 100% of a propeller radius.

The remaining locations of chords 615-617 may also be defined with respect to, e.g., a distance from a propeller radius as discussed above. Alternatively, the locations of chords 615-617 may be defined with respect to each other, to root chord 614, or to tip chord 619. For example, a location of middle chord 616 may be defined as being, e.g., a fraction of the distance (such as e.g., one quarter, one third, one half, two thirds, or three quarters) from root chord 614 to tip chord 619, a fraction of the distance from root chord 614 to blade tip 611, a fraction of the distance from hub center 632 to tip chord 619, or a fraction of the distance from hub center 632 to blade tip 611. Alternatively, a location of middle chord 616 may be defined at the location of maximum chord length of propeller blade 620. Similarly, inner intermediate chord 615 may be defined as being located at a fraction of the distance from hub center 632 or root chord 614 to middle chord 615. Outer intermediate chord 617 may be defined as being located at a fraction of the distance from middle chord 615 to root chord 619 or blade tip 611. In the illustrated example, each of propeller blades 612b and 612c depict various chords that are defined as follows: the location of a root chord 614 is defined at a distance of 20% of the propeller radius from the propeller rotational axis at hub center 632; the location of tip chord 619 is defined at a distance of between 95% and 100% of the propeller radius from the propeller rotational axis at hub center 632; the location of middle chord 616 is defined at a distance of halfway between root chord 614 and blade tip 611; the location of inner intermediate chord 615 is defined at a distance of halfway between root chord 614 and middle chord 616; and the location of outer intermediate chord 617 is defined at a distance of halfway between root chord 614 and blade tip 611.

Under these example definitions, the chords 614-619 may be located at distances from the hub center 632 of 20%, 40%, 60%, 80%, and between 95% and 100%, respectively. A root taper ratio may then be taken as a ratio of the length c_{R} of root chord 619 to an average chord length mean (c). Note that the average chord length may comprise an average over the entire blade length from root chord 619 to blade tip 611, not necessarily an average of the few discrete chords 614-619 mentioned here. Propeller 612c may have a smaller root taper ratio TR than propeller 612b. For instance, under the example definitions given above, propeller 612b may comprise a root taper ratio of, e.g., 1.3, while propeller 612c may comprise a root taper ratio of, e.g., 0.8. Further, propeller 612c may exhibit favorable characteristics in both the lift and cruise configurations as compared to propeller 612b.

In addition to a root taper ratio, the propeller blade design may be characterized by relationships of the relative lengths of chords. For example: blade tip 611, or a tip chord 619, may have a length that is greater than the length of root chord 614; inner intermediate chord 615 may have a length that is greater than the length of a tip 611, or a tip chord 619; outer intermediate chord 617 may have a length that is greater than the length of inner intermediate chord 615; middle chord 615 may have a length that is greater than the length of outer intermediate chord 617. Further, a design of propeller blades may be characterized by the relative lengths of a chords, such as a maximum chord and a smaller chord, a root chord and a tip chord, an inner intermediate chord and an outer intermediate chord, etc. For instance, in some embodiments a maximum chord length may be at least 1.2, 1.4, or 1.6 times the length of root chord 614. In some embodiments, maximum chord length may be no more than 1.9, 1.7, or 1.5, 1.4, or 1.6 times the root chord. Therefore, in some embodiments a maximum chord length may be, e.g., between 1.2 and 1.9 times a length of root chord 614. In some embodiments the lengths of root chord 614 and tip chord 619 may be within, e.g., 10%, 20%, or 30% of each other. In some embodiments the lengths of inner intermediate chord 615 and outer intermediate chord 617 may be within, e.g., 10%, 20%, or 30% of each other. In some embodiments the lengths of inner intermediate chord 615, or outer intermediate chord 617, may be within, e.g., 10%, 20%, or 30% of the length of middle chord 616.

It should be understood that the various characterizations discussed above may be present in combination with each other in some embodiments of the present disclosure. By way of example, a propeller blade design may comprise a root taper ratio of 0.7 and a ratio of maximum chord length to root chord length of 1.4.

FIG. 6C schematically illustrates a graph 650 of example power ratios (eqn. 3) as a function of root taper ratio (on the horizontal axis) and tip Mach number (on the vertical axis), as well as an optimal zone of operation 651 for lift and cruise type VTOL aircraft. The tip Mach number values are given assuming a drag coefficient of 0.5, a blade aspect ratio of 3.3, an airspeed of 60 m/s and a blade pitch at the root of 30°. As can be seen in the graph 650, high power ratios are achievable within the optimal zone of operation 651, comprising low tip Mach numbers to minimize noise generation, by using propeller blade designs according to embodiments of the present disclosure. For example, an optimal zone of operation 651 under the disclosed conditions may comprise a range from, e.g., tip Mach numbers from 0.30 to 0.50 and root taper ratios between 0.6 and 0.95.

### B. Example Propeller Clocking Embodiments

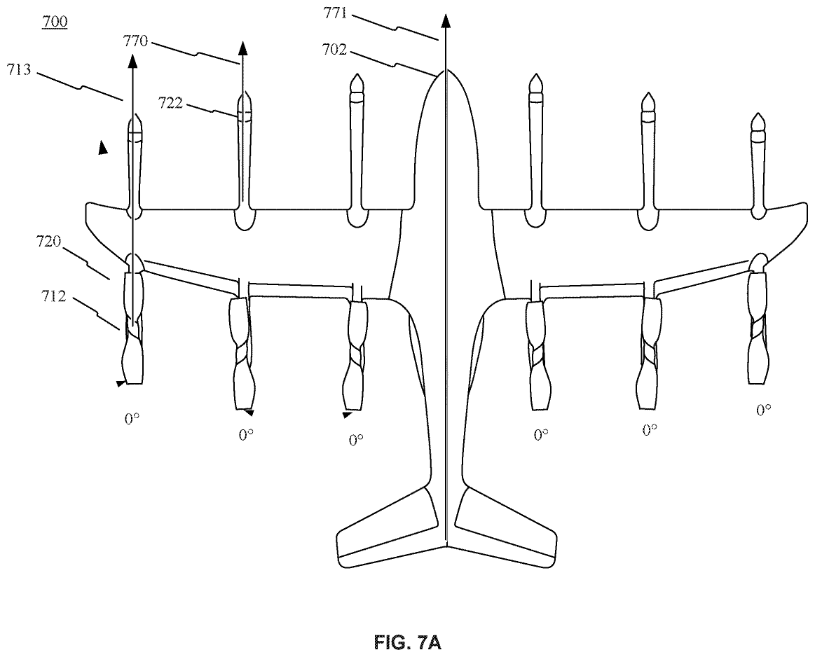

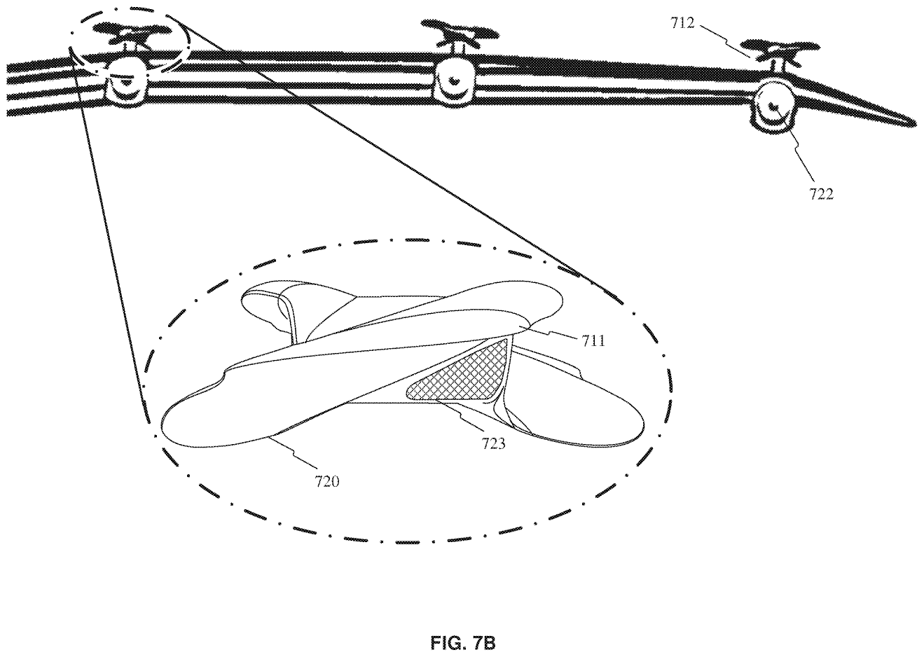

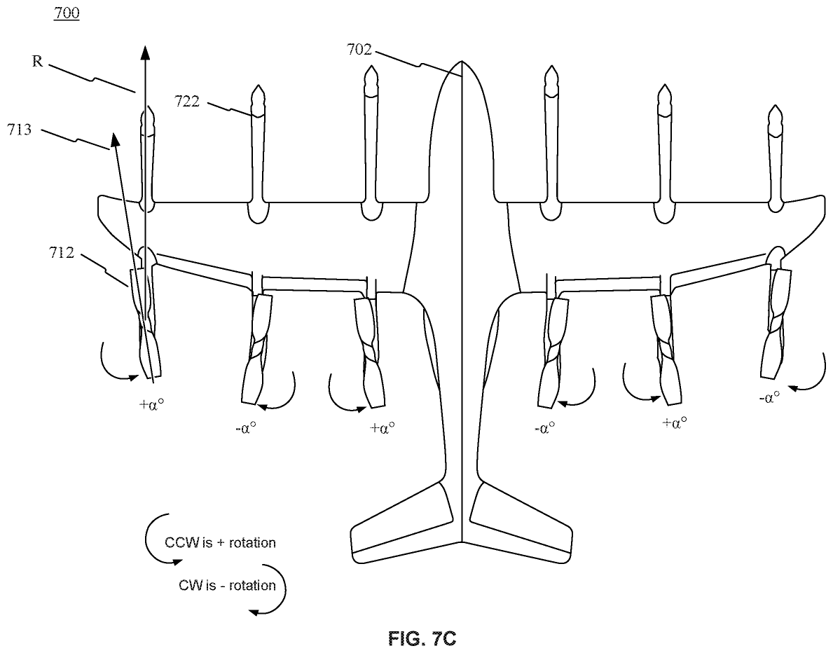

FIGS. 7A-7C illustrate an example VTOL aircraft 700, consistent with embodiments of the present disclosure. VTOL aircraft 700 may be, e.g., similar to VTOL aircraft 100 of FIGS. 1A and 1B. In some embodiments, lift propellers 712 may be stowed in the cruise configuration such that a first reference axis of the lift propeller is at a clocked angle with respect to a second reference axis of the VTOL aircraft when in the cruise configuration. For example, the second reference axis may comprise, e.g., a longitudinal axis 770 of a boom 722 or a longitudinal axis 771 of fuselage 702 of the VTOL aircraft 700, or another axis that is representative of a forward-looking direction of VTOL aircraft 700. For a two bladed lift propeller 712 as shown in FIGS. 7A-7C, the first reference axis may comprise a longitudinal axis 713 of the lift propeller. Thus a lift propeller 712 may be stowed such that its longitudinal axis 713 is offset from a second reference axis of the VTOL aircraft by a predetermined angle. In some embodiments, the predetermined angle may be in a direction of rotation of the lift propeller 712. In some embodiments, the predetermined angle may comprise, e.g., between 2 and 20 degrees, such as approximately 7 or 8 degrees. According to some disclosed embodiments, stowing the propeller 712 at even a small angle from the reference axis may generate large reductions in drag in the cruise configuration.

For example, FIG. 7A illustrates an example un-clocked cruise configuration, consistent with embodiments of the present disclosure. In this configuration, longitudinal axis 713 of propeller blades 720 may be substantially parallel with the forward direction, such as with a longitudinal axis of boom 722 or fuselage 702. However, as seen in the close-up front view of a lift propeller 712 in FIG. 7B, this may not be an optimal stowing angle. For instance, incoming air may become trapped or otherwise impinge on a region 723 of propeller 712 (such as a hub or other portion under the blades 720) such that high drag forces are generated there. By turning the blade slightly in the blade rotation direction (e.g., by moving a front tip 711 to the right in the illustration) air flow may be reduced at this region.

Therefore, as shown in FIG. 7C, each propeller may be stowed in cruise such that its longitudinal axis 713 is at an angle α with respect to a reference axis R, such as a longitudinal axis of boom 722 or fuselage 702. For example, in some embodiments, α may equal, e.g., between 2 and 20 degrees, such as 2, 3, 4, 5, 6, 7, 8 or 9 degrees. As seen in FIG. 7C, in some embodiments the lift propellers 712 may be configured as counter-rotating pairs. For instance, in the illustrated example embodiment a VTOL aircraft may comprise six lift propellers. Three of the lift propellers may be configured to rotate in the clockwise direction as viewed from above, while the other three may rotate counterclockwise. In some embodiments when these lift propellers are stowed at a clocked angle, the angle may be taken in the clockwise or counterclockwise direction respectively.

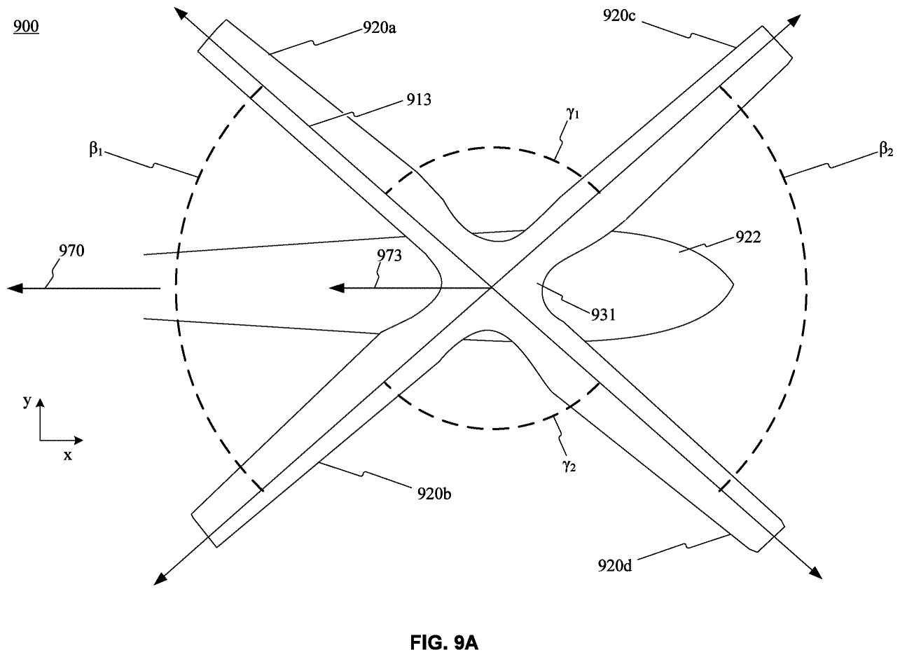

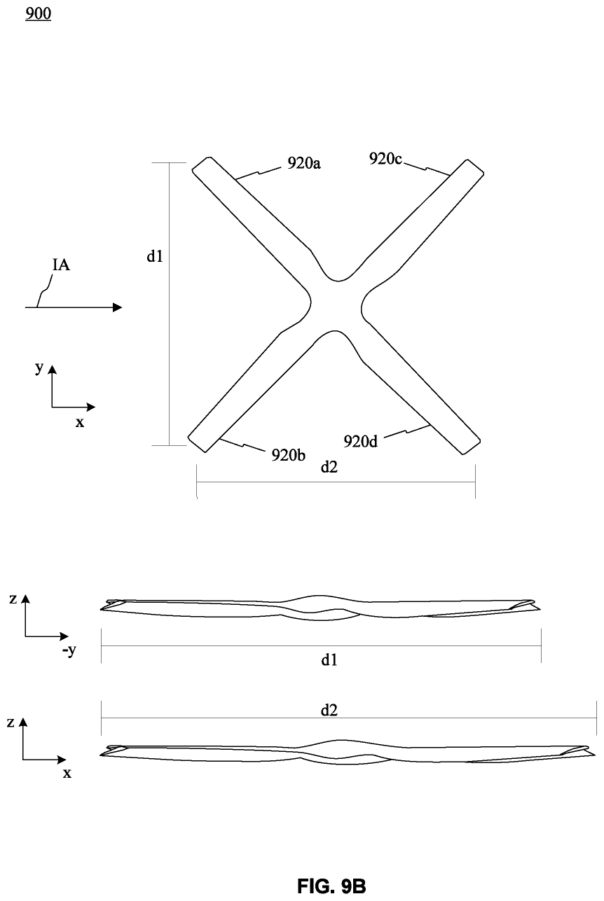

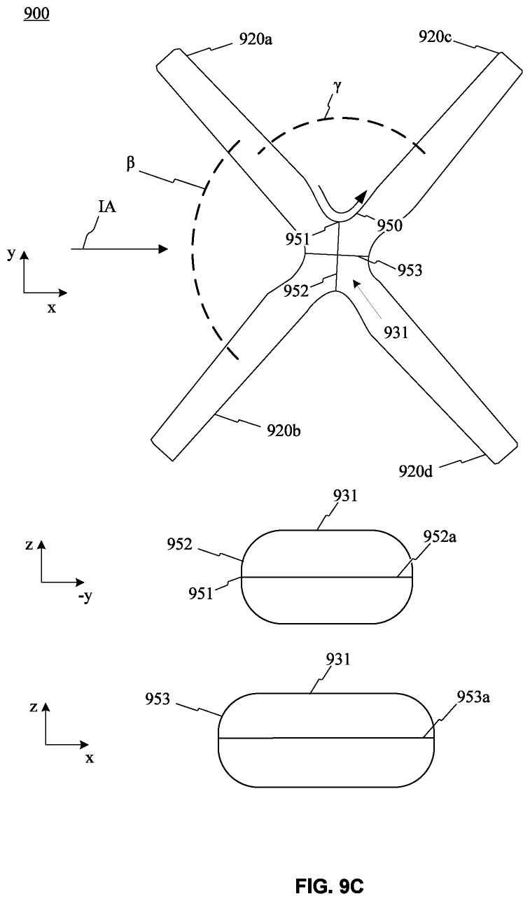

Furthermore, in some embodiments, lift propellers having more than two blades may be stowed at a clocked angle. For example, as shown at FIGS. 9A-9C below, in some embodiments a lift propeller may be a four-bladed such that the lift propeller is stowed with two blades facing toward the direction of forward flight. In such a case, the first reference axis may comprise, e.g., a line bisecting the two longitudinal axes of the two forward-facing blades, and the first reference axis may be rotated with respect to the second reference axis as discussed above. In some embodiments, a lift propeller may comprise, e.g., six blades, in which case the first reference axis may again comprise the longitudinal axis of a single blade.

In some embodiments, lift propellers may be stowed in the clocked angle by a controller of the electric engine. In some embodiments, the lift propeller may comprise a locking mechanism configured to lock the lift propeller in the clocked angle when operating in the cruise configuration. In some embodiments, the control and/or locking mechanism may be adjustable to adjust the desired clocking angle.

Some embodiments of the present disclosure have illustrated lift propellers as having two blades. A two-bladed design may be ideal for minimizing drag by aligning a longitudinal axis of the blade with the direction of travel to reduce frontal surface area. However, embodiments of the present disclosure are not limited to this, and in some embodiments lift propellers may have more than two blades as discussed above at paragraph [0044]. For example, a lift propeller may comprise, e.g., three, four, five, six, or more blades. In general, it may be more preferable from a drag reduction standpoint to provide an even number of blades. For example, in some embodiments a four-bladed propeller may generate less drag than a three-bladed propeller of comparable dimensions and contours. In addition to increasing lifting power, a larger number of blades may offer a more rotationally symmetrical blade arrangement that may be beneficial for reducing unwanted vibrations as discussed below.

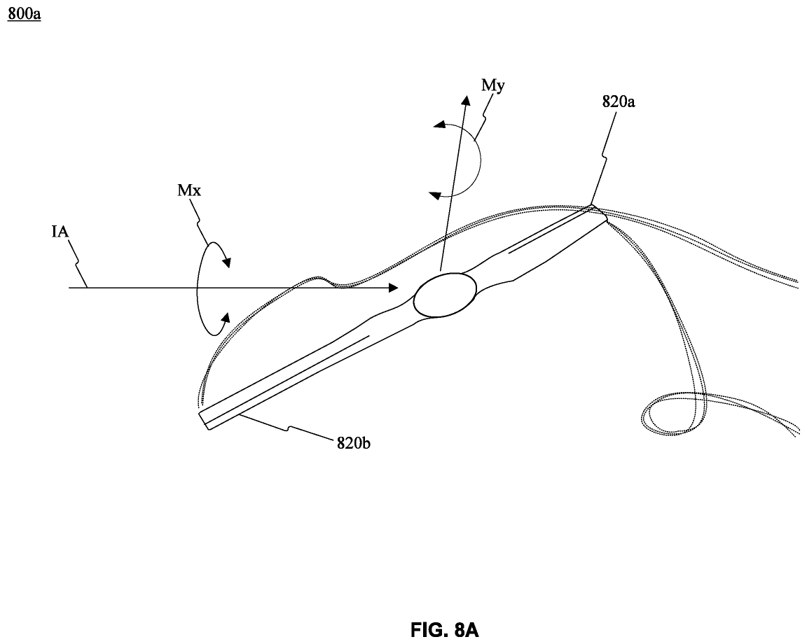

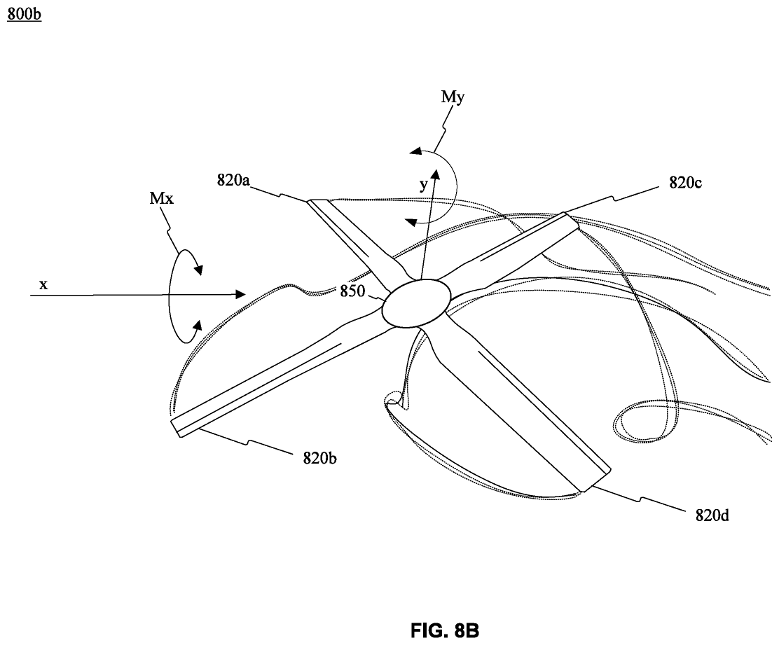

FIGS. 8A and 8B illustrate example lift propellers 800a and 800b, respectively, for a VTOL aircraft, according to a comparative embodiment. Lift propeller 800a (see e.g., FIG. 8A) comprises a two-bladed propeller having a first blade 820a a second blade 820b. Lift propeller 800b (see FIG. 8B) comprises a four-bladed propeller having a first blade 820a, a second blade 820b, a third blade 820c and a fourth blade 820d.

During transition between vertical and horizontal flight modes, a rotating lift propeller may be impacted by edgewise airflow from incoming airflow IA (see e.g., FIG. 8A) in a substantially horizontal direction. The impact of such airflow against the edges of the rotating propeller blades has consequences on propeller performance, fatigue and vibration. For example, the constant rotation of the blades relative to the steady incoming airflow IA causes an advancing blade (such as 820a) to experience a larger force than a retreating blade (such as 820b), resulting in an imbalanced application of force among the blades. Further, because the relative angle of a blade is constantly changing with respect to the direction of incoming airflow IA, the point of application of a thrust vector varies periodically according to the propeller RPM. This creates oscillatory loads on the propeller hub that can have a negative effect on structure fatigue and ride comfort.

Two problematic components of the oscillatory loads are an oscillatory rolling moment Mx about an x axis and an oscillatory pitching moment My about a y-axis, which may cause the propeller to roll left or right and nose-up or nose-down, respectively, during a revolution of the propeller. These periodic oscillations may be represented as a sinusoidal curve in which peak-to-peak amplitudes are proportionate to the maximum loads experienced in alternating directions. It may therefore be desirable to minimize the amplitudes of these oscillations.

Two-bladed propellers may be unable to cancel such gyroscopic and higher dynamic loads. However, there may be improved suppression of oscillations for the case of a propeller having more than two blades. For a four-bladed propeller 800b (see e.g., FIG. 8B), pairs of blades may be arranged orthogonal to each other. For example, first blade 820a and fourth blade 820d, may be orthogonal second blade 820b and third blade 820c. Stated another way, the longitudinal axes (not shown) of first blade 820a and fourth blade 820d may be offset by +/−90 degrees from second blade 820b and third blade 820c. This orthogonality may result in a cancellation of forces and may serve to minimize the amplitudes of the oscillatory loads discussed above.

However, VTOL aircraft require special considerations that may not apply to conventional aircraft. For example, a typical propeller-based aircraft is not designed to stow any propellers in a stationary position during flight, and as such, the drag profile considerations of conventional aircraft propellers are very different from those of VTOL lift propellers. While four bladed lift propellers may advantageously reduce oscillatory loads as discussed above, they also have a large frontal area compared to two-bladed lift propellers, resulting in larger drag forces when stowed during horizontal flight. These larger drag forces may reduce efficiency, speed, and range of VTOL aircraft.

Embodiments of the present disclosure provide improved aerodynamic designs of lift propellers. In some embodiments, a stagger angle (i.e., an angle between adjacent propeller blades in a rotational plane of the propeller blades) may be specially tailored to balance the competing needs of the lift and cruise configurations in VTOL aircraft. For example, a stagger angle between each of the forward and rear-facing blade pairs (when arranged in a stowed orientation) may be smaller than a stagger angle between laterally-facing blade pairs, as further discussed below. This may decrease the frontal area by reducing an overall width of the propeller as viewed from the perspective of incoming airflow IA. Further, the propeller hub shape may comprise a corresponding asymmetry. For example, the hub may be made relatively narrow along a dimension facing the incoming airflow IA to allocate structural support in a way that minimizes drag forces. Finally, the propeller blades and propeller hub may comprise an integrated design that forms a smooth surface having minimal discontinuities, bulges, or other drag-inducing features.

### C. Example Oblique Blade Embodiments

FIGS. 9A-9C illustrate an example propeller apparatus 900 for a VTOL aircraft, consistent with embodiments of the present disclosure. Propeller apparatus 900 may comprise, e.g., a lift propeller on a VTOL aircraft similar to, e.g., VTOL aircraft 100 of FIGS. 1A and 1B.

Propeller apparatus 900, may comprise a first blade 920a, a second blade 920b, a third blade 920c, and a fourth blade 920d, each blade comprising a longitudinal axis 913. The blades may be coupled to an integrated hub 931 and mounted on a support structure, such as, e.g., a boom 922 or other structural component of a VTOL aircraft.

The propeller blades of propeller apparatus 900 are shown in an example stowed orientation for minimizing drag during horizontal flight. In the example stowed configuration, a line 973 (a first reference axis) bisecting the longitudinal axes of first propeller blade 920a and second propeller blade 920b may be oriented parallel to a longitudinal axis 970 of boom 922 (a second reference axis). However, embodiments of the present disclosure are not limited to this configuration. For example, in some embodiments the propeller apparatus 900 may be stowed at a clocked angle such that the first reference axis is offset from the second reference axis as discussed above with respect to FIGS. 7A-7C.

In order to reduce drag in the stowed configuration, the stagger angles between different pairs of blades 920a-d may be non-uniform. Here, a “stagger angle” refers to the angle between two adjacent propeller blades 920a-d in the plane of rotation of the propeller blades (i.e., in the plane of FIG. 9A, which may alternatively be referred to as the azimuthal plane). As discussed herein with respect to propeller blades, two propeller blades may be “adjacent” if there is no intervening propeller blade between them in the plane of rotation. The angle may be taken with respect to corresponding reference points or corresponding reference lines in two adjacent blades. For example, as illustrated, a first stagger angle β₁ between first blade 920a and second blade 920b is taken as the angle between their longitudinal axes 913. Alternatively or additionally, the stagger angle may be taken with respect to another reference, such as, e.g., the leading or trailing edges of the first blade 920a and second blade 920b. In some embodiments, an opposite stagger angle β₂ between third blade 920c and fourth blade 920d may be equal to β₁. However, embodiments of the present disclosure are not limited to this. For example, in some embodiments drag performance may be improved when β₂ is greater than β₁. Further, in some embodiments β₂ may be less than β₁. A second stagger angle γ₁ is taken between first blade 920a and third blade 920c Here again, a further opposite stagger angle 12 between fourth blade 920d and second blade 920b may be equal to, greater than, or less than γ₁. For example, in some embodiments γ₁ and γ₂ may differ by, e.g., +/−5 degrees. However, for simplicity, the smaller stagger angles β₁ and β₂ may generally be referred to as “β,” and the larger stagger angles γ₁ or γ₂ may generally be referred to as “γ.”

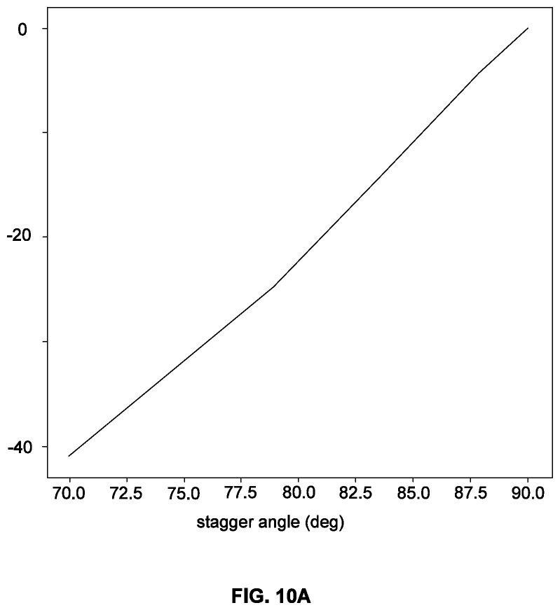

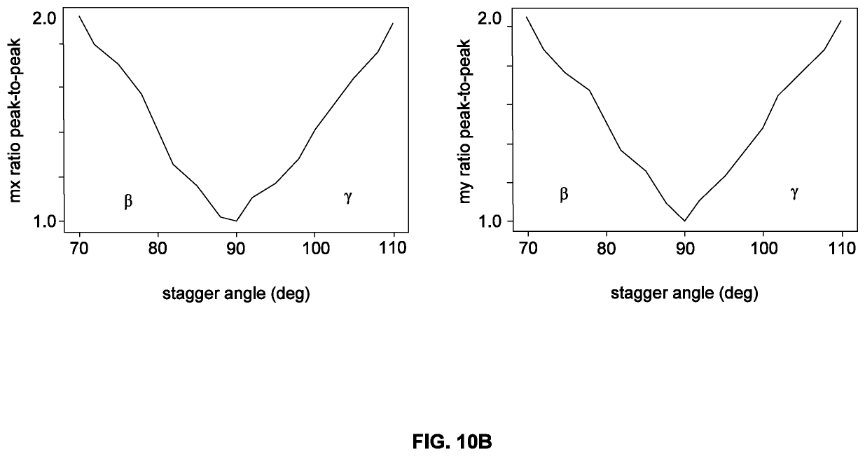

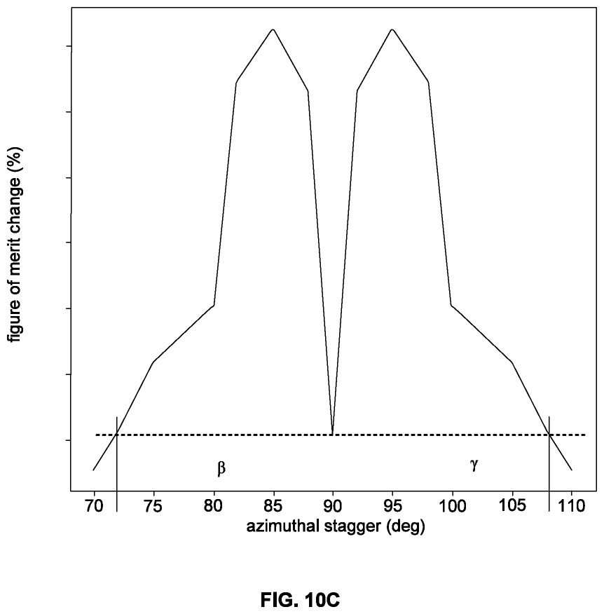

Because the first stagger angle β is less than the second stagger angle γ, the first stagger angle β may be less than 90 degrees. In some embodiments, the second stagger angle γ may comprise a supplementary angle such that β+γ=180 degrees. Therefore the second stagger angle γ may be greater than 90 degrees. The choice of specific values for the stagger angles may be determined based on a tradeoff between propeller performance when the propeller is operating and drag conditions when the propeller is stowed. For example, as β decreases, a frontal area of propeller apparatus 900 is reduced to improve drag. However, oscillatory loads increase as the stagger angles deviate from 90 degrees, and propeller efficiency (e.g., a ratio between the ideal and actual propeller shaft power required for hovering) may also vary as a function of stagger angle. These competing factors are discussed further with respect to FIGS. 10A-10C. Thus, an optimal design may comprise reducing β as allowable within acceptable limits of both propeller efficiency and oscillatory loads and other vibrations. In some embodiments, the first stagger angle β may be, e.g., from 65 degrees to 85 degrees. In some embodiments, β may be, e.g., from 70 degrees to 85 degrees, or from 74 degrees to 83 degrees. Similarly, the second stagger angle γ may fall within corresponding ranges, such as from 95 degrees to 115 degrees, from 95 degrees to 110 degrees, or from 97 degrees to 106 degrees inclusive.

FIG. 9B illustrates the effect on drag reduction of the arrangement of FIG. 9A, as compared to the case in which all stagger angles are 90 degrees. At the top of the figure is a bird's eye view in the azimuthal plane, similar to the view of FIG. 9A. At the bottom are a view of a first distance d1 between the first blade 920a and the second blade 920b, and a view of a second distance d2 between, e.g., second blade 920b and the fourth blade 920d. As a result of the oblique stagger angles β and γ, the first distance d1 may be shorter than the second distance d2, resulting in a reduced total frontal area, which in turn results in a lower drag. For example, in some embodiments, a first stagger angle β of 80 degrees may achieve a drag reduction of, e.g., 20%. An angle β of 70 degrees may achieve a drag reduction of, e.g., 40%. While the second distance d2 may be larger than the distance d2 for the case in which all stagger angles are 90 degrees, this is not a concern for drag considerations due to the blades 920 being stowed in the predetermined orientation as shown.

In some embodiments a relationship between first distance d1 and second distance d2 may be characterized in relative terms. For example, in some embodiments, d1/d2 may comprise a number less than one. As an illustrative example, in some embodiments a value d1/d2 may equal: 0.848 for β=65 degrees; 0.885 for β=70 degrees; 0.918 for β=75 degrees; 0.967 for β=83 degrees; and 0.978 for β=85 degrees. More generally, in some embodiments a value d1/d2 may be between, e.g., 0.840 and 0.994.

Additionally, some descriptions may assume that all propeller blades have an equal radius. However, embodiments of the present disclosure are not limited to this. In some embodiments, one or more blades may be longer or shorter than one or more other blades. Therefore in some embodiments it may be preferable to characterize the propeller configuration in terms of stagger angles β or γ.

FIG. 9C illustrates example integrated hub and blade designs of propeller apparatus 900, consistent with embodiments of the present disclosure. A hub 931 may join first blade 920a, second blade 920b, third blade 920c, and fourth blade 920d to form a continuous surface contour. For example, the continuous surface contour may be designed to reduce or eliminate surface discontinuities such as sharp corners, level step increases, or other sources of excrescence drag.

Furthermore, the elbow contours between adjacent blades may be designed to eliminate any outward bulging at a hub portion between them (such as, e.g., bulge 850 between propeller blades 820a-d as seen in the comparative embodiment of FIG. 8B). For example, an elbow contour 950 leading from, e.g., first blade 920a to third blade 920b may comprise a local minimum at point 951 as viewed in the azimuthal plane. In some embodiments, point 951 may comprise a saddle point. A saddle point may refer to a point on a surface contour that comprises a local minimum along a first direction and local maximum along a second direction. For example, hub 931 may comprise an aerodynamic shape (such as, e.g., elliptical, rounded rectangle, or other shape having generally smooth contours and rounded edges) in a first cross sectional plane 952. As seen in FIG. 9C, the point 951 may comprise a local minimum on the surface in the y-direction in the x-y plane, and may comprise a local maximum on the surface in the y direction in the first cross section plane y-z. More generally, the elbow contour may be designed to eliminate any outward bulging between the first blade and the second blade. Further, while the elbow contour 950 is discussed with respect to a surface leading from first blade 920a to third blade 920c, the surface contours between any two adjacent blades may comprise a similar design. For example, in some embodiments, an elbow contour between second blade 920b and fourth blade 920d may comprise a saddle point as described above. In some embodiments, all elbow contours between each pair of adjacent blades may comprise such saddle points.

Furthermore, while first cross sectional plane 952 was described above as lying in the y-z plane of FIG. 9C, embodiments of the present disclosure are not limited to this configuration. For example, in some embodiments, the first cross sectional plane 952 may precisely bisect the second stagger angle γ. However, because the elbow contour 950 transitions from a trailing edge of first blade 920a to a leading edge of third blade 920c the elbow contour may not be symmetric about the saddle point 951, and therefore the first cross-sectional plane may not perfectly bisect the second stagger angle γ. In some embodiments, for example, an angle between the first blade 920a and the first cross section plane 952 may be, e.g., between 0.4γ and 0.6γ. The same may hold true for other saddle points. For example, an angle between second blade 920b and a second cross sectional plane 953 may be, e.g., between 0.4β and 0.6β.

Additionally, hub 931 may be designed with an asymmetry to reduce drag forces in the stowed position. For example, hub 931 may comprise a first aerodynamic shape in the first cross sectional plane 952 and a second aerodynamic shape in the second cross sectional plane 953. To reduce a frontal surface area, a first length 952a of the first aerodynamic shape in the rotational plane of the propeller may be shorter than a length 953a of the second aerodynamic shape 953 in the rotational plane of the propeller. By “squeezing” the hub in the dimension that faces incoming airflow IA and elongating it in a dimension that does not face the incoming airflow IA, it may be possible to distribute bulk material of the hub 931 to allocate structural support to the blades 920 in a more aerodynamic way. Furthermore, this allocation of bulk material may allow for a lower profile hub as discussed above with respect to FIG. 4.

As discussed above, VTOL aircraft face special challenges that may not be an issue for conventional aircraft. For example, conventional aircraft propellers may be designed to operate continuously when flying, and as such may not require a design that balances high performance in a lift configuration with low drag in a stowed configuration. FIGS. 10A-10C illustrate example performance parameters that may impact lift propeller designs according to embodiments of the present disclosure.

FIG. 10A illustrates an example graph showing drag reduction as a function of the first stagger angle β, consistent with embodiments of the present disclosure. The example values are consistent with the examples discussed above with respect to FIG. 9B. For instance, a value β=80 degrees corresponds to a 20% reduction and a value β=70 degrees corresponds to a 40% reduction. A value β=90 degrees corresponds to conventional four-blade propeller having orthogonal blades, and so it corresponds to a 0% reduction from the conventional case. As seen in FIG. 10A for the example graph, there is an approximately linear relationship between the β and drag reduction within the range of 90 to 70 degrees.

FIG. 10B illustrates example ratios of peak-peak oscillatory moments between oblique and orthogonal blades as a function of stagger angle. The graph on the left illustrates an oscillatory rolling moment Mx and the graph on the right illustrates an oscillatory pitching moment My. Because the graph represents a ratio to the orthogonal case at 90 degrees, the oscillatory loads are minimized at 1.0 for this angular at a value. Values below 90 correspond to the first stagger angle β, and values above 90 correspond to the second stagger angle γ. It can be seen that, for the example, graph shown, both rolling and pitch moments increase in an approximately linear fashion and approximately double at 20 degrees from orthogonality. Therefore the degree of obliqueness that may be practically achieved in the lift propeller design is limited in part by this relationship.

Further, FIG. 10C illustrates a change in propeller efficiency as a function of stagger angle. As discussed above, propeller efficiency may refer to the ratio between an ideal and an actual propeller shaft power required to achieve hovering. While propeller efficiency may be considered an additional limiting factor on the lower bound of the first stagger angles, it was unexpectedly found that propeller efficiency does not necessarily decrease monotonically as the angles deviate from 90 degrees. Instead, it was found that efficiency increases slightly before decreasing. For instance, as illustrated by the dashed horizontal line in the example graph of FIG. 10C, propeller efficiency does not fall below the value seen at 90 degrees until the stagger angle deviates from 90 by approximately 18 degrees, such as, e.g., 72 degrees or 108 degrees. Thus it may be feasible to achieve a smaller value of β than might be expected.

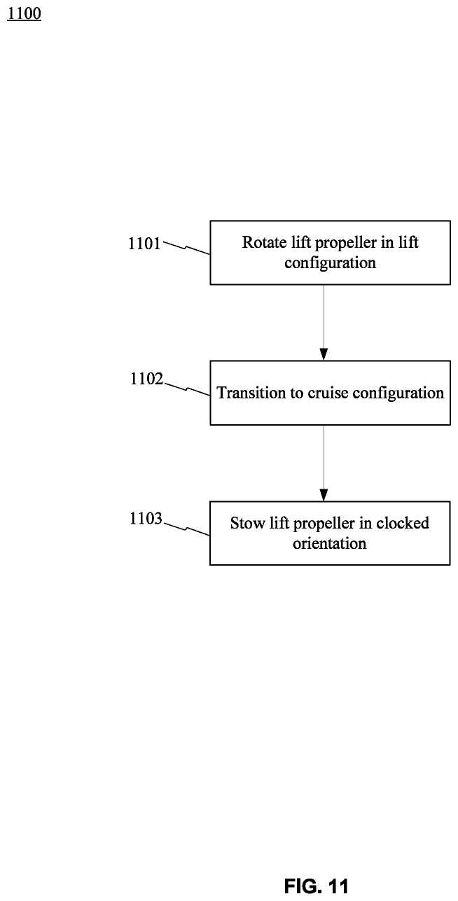

FIG. 11 illustrates an example method 1100 of operating a VTOL aircraft, such as, e.g., VTOL aircraft 100 of FIGS. 1A and 1B. At step 1101, the VTOL aircraft may rotate one or more lift propellers in a lift configuration. For example, in the lift configuration the VTOL aircraft may be ascending, descending, hovering, etc.

At step 1102, the VTOL aircraft may enter a transition phase between the lift configuration and a cruise configuration. During the transition phase, the VTOL aircraft may transition from hovering to wing-borne flight, such as by tilting one or more tilt propellers into a forward flight orientation. When full wing-borne flight is achieved, the VTOL aircraft may shut down its lift propellers.

At step 1103, the VTOL aircraft may stow the lift propellers into a low drag orientation by clocking the lift propeller blades with respect to the direction of forward motion. For example, clocking the lift propeller blades may comprise positioning a reference axis of the lift propeller at an angle with respect to a longitudinal axis of a fuselage of the VTOL aircraft in a cruise configuration. For a two-bladed propeller, the reference axis may comprise, e.g., a longitudinal axis of the propeller blade. For four-bladed lift propeller, the reference axis may comprise a line bisecting two longitudinal axes of two adjacent blades of the lift propeller. The angle may be, e.g., from 2 to 20 degrees, from 2 to 10 degrees, or from 4 to 10 degrees.

Additional aspects of the present disclosure may be further described via the following clauses:
1. A lift apparatus for a vertical takeoff and landing (VTOL) aircraft, comprising: a lift propeller comprising a first blade, a second blade, a third blade, and a fourth blade; wherein:
   the first blade is adjacent to the second blade and to the third blade; and
   a first stagger angle between the first blade and the second blade is less than a second stagger angle between the first blade and the third blade.
2. The lift apparatus of clause 1, wherein the first stagger angle is from 65 to 85 degrees.
3. The lift apparatus of clause 1 or 2, wherein the second stagger angle is from 95 to 115 degrees.
4. The lift apparatus of any of clauses 1 to 3, wherein the first stagger angle is from 70 to 85 degrees.
5. The lift apparatus of clause 4, wherein the second stagger angle is from 95 to 110 degrees.
6. The lift apparatus of any of clauses 1 to 5, wherein the first stagger angle is from 74 to 83 degrees.
7. The lift apparatus of clause 6, wherein the second stagger angle is from 97 to 106 degrees.
8. The lift apparatus of any of clauses 1 to 7, wherein a sum of the first stagger angle and the second stagger angle is 180 degrees.
9. The lift apparatus of any of clause 1 to 8, wherein a third stagger angle between the third blade and the fourth blade is equal to the first stagger angle.
10. The lift apparatus of any of clauses 1 to 9, wherein a fourth stagger angle between the second blade and the fourth blade is equal to the second stagger angle.
11. The lift apparatus of any of clauses 1 to 10, further comprising:
a hub joining the first blade, the second blade, the third blade, and the fourth blade.
12. The lift apparatus of clause 11, wherein the hub joins the first blade, the second blade, the third blade, and the fourth blade to form a continuous surface contour.
13. The lift apparatus of clause 11 or 12, wherein an elbow contour leading from the first blade to the third blade comprises a saddle point at the hub.
14. The lift apparatus of clause 13, wherein:
the saddle point lies on a first cross sectional plane of the hub; and
an angle between the first blade and the first cross sectional plane is between 40% and 60% of the second stagger angle.
15. The lift apparatus of any of clauses 11 to 15, wherein:
the hub comprises a first shape in a first cross sectional plane of the hub, the first cross sectional plane extending between the first blade and the third blade; and the hub comprises a second shape in a second cross sectional plane of the hub, the second cross sectional plane extending between the first blade and the second blade.
16. The lift apparatus of clause 15, wherein a first length of the first shape in a rotational plane of the lift propeller is shorter than a second length of the second shape in the rotational plane of the lift propeller.
17. The lift apparatus of any of clauses 11 to 16, wherein:
a maximum height of the hub is equal to or below a maximum height of the first blade by more than 5% of a radius of the first blade.
18. The lift apparatus of any of clauses 11 to 17, wherein:
a maximum height of the hub is equal to or below a maximum height of a tip of the first blade by more than 5% of a radius of the first blade, wherein the tip comprises a portion of the first blade between 90% and 100% of the radius of the first blade.
19. The lift apparatus of any of clauses 11 to 18, wherein:
a maximum height of the hub is equal to or below a maximum height of the first blade by more than 2% of a radius of the first blade.
20. The lift apparatus of any of clauses 11 to 19, wherein:
a maximum height of the hub is not above a maximum height of a tip of the first blade by more than 2% of a radius of the first blade, wherein the tip comprises a portion of the first blade between 90% and 100% of the radius of the first blade.
21. The lift apparatus of any of clauses 11 to 20, wherein:
a maximum height of the hub is less a height of a first point on the first blade; and
a maximum height of the hub is greater than a height of a tip of the first blade, wherein the tip comprises a portion of the first blade between 90% and 100% of a radius of the first blade.
22. A vertical takeoff and landing (VTOL) aircraft, comprising the lift apparatus of any of clauses 1 to 21.
23. A lift apparatus for a vertical takeoff and landing (VTOL) aircraft, comprising: a lift propeller comprising a plurality of blades configured to rotate about a rotational axis, each blade comprising a root chord and a blade tip;
wherein:
   the root chord of each of the plurality of blades is located at a distance from the rotational axis of between 15% and 25% of a radius of the blade; and
   each of the plurality of blades comprises a root taper ratio of 1 or less, wherein the root taper ratio is a ratio of a length of the root chord to an average chord length of the blade from the root chord to the blade tip.
24. A lift apparatus for a vertical takeoff and landing (VTOL) aircraft, comprising:
   a lift propeller comprising a plurality of blades configured to rotate about a rotational axis, each blade comprising:
      a root chord;
      a middle chord;
      a tip chord; and
      a blade tip;
         wherein:
         the root chord of each of the plurality of blades is located at a distance from the rotational axis of between 18% and 22% of a radius of the blade;
         the tip chord of each of the plurality of blades is located at a distance from the rotational axis of between 90% and 100% of the radius of the blade;
         the middle chord is located between the root chord and the blade tip;
         a length of the tip chord is greater than a length of the root chord; and
         a length of the middle chord is greater than the length of the of the tip chord and the length of the root chord.
25. The lift apparatus of clause 24, wherein the middle chord is located at a distance halfway between the root chord and the blade tip.
26. The lift apparatus of clause 24 or 25, further comprising:
an inner intermediate chord located between the root chord and the middle chord; and
an outer intermediate chord located between the middle chord and the blade tip, wherein a length of the outer intermediate chord is greater than a length of the inner intermediate chord.
27. The lift apparatus of clause 26, wherein the length of the inner intermediate chord is greater than the length of the tip chord.
28. The lift apparatus of clause 26 or 27, wherein the length of the inner intermediate chord is greater than the length of the root chord.
29. The lift apparatus of any of clauses 26 to 28, wherein the length of the inner intermediate chord is less than the length of the middle chord.
30. The lift apparatus of any of clauses 26 to 29, wherein the length of the outer intermediate chord is greater than the length of the tip chord.
31. The lift apparatus of any of clauses 26 to 30, wherein the length of the outer intermediate chord is greater than the length of the root chord.
32. The lift apparatus of any of clauses 26 to 31, wherein the length of the outer intermediate chord is greater than the length of the middle chord.
33. The lift apparatus of any of clauses 26 to 32, wherein:
the inner intermediate chord located at a distance halfway between the root chord and the middle chord; and
the outer intermediate chord is located at a distance halfway between the middle chord and the blade tip.
34. The lift apparatus of any of clauses 24 to 33, wherein:
each of the plurality of blades comprises a root taper ratio of 1 or less, wherein the root taper ratio is a ratio of a length of the root chord to an average chord length of the blade from the root chord to the blade tip.
35. The lift apparatus of any of clauses 24 to 34, wherein the lift propeller comprises a two-bladed propeller.
36. The lift apparatus of any of clauses 24 to 35, each blade further comprising: a longitudinal axis in a radial direction from the rotational axis;
wherein the blade is asymmetric about the longitudinal axis.
37. A vertical takeoff and landing (VTOL) aircraft, comprising the lift apparatus of any of clauses 24 to 36.
38. A lift apparatus for a vertical takeoff and landing (VTOL) aircraft, comprising:
   a lift propeller;
   an engine configured to rotate the lift propeller;
   a controller configured to control the engine while operating the VTOL aircraft in forward flight in a cruise configuration to position a first reference axis of the lift propeller at an angle with respect to a second reference axis of the VTOL aircraft in a cruise configuration; and
a support structure configured to support the engine and the lift propeller,
   wherein:
      the first reference axis comprises one of a longitudinal axis of a blade of the lift propeller or a line bisecting two longitudinal axes of two blades of the lift propeller;
      the second reference axis comprises one of a longitudinal axis of the support structure or a longitudinal axis of a fuselage of the VTOL aircraft; and
      the angle is from 2 to 20 degrees.
39. The lift apparatus of clause 38, wherein:
   the lift propeller comprises a two-bladed propeller, and
   the first reference axis comprises the longitudinal axis of the blade of the lift propeller.
40. The lift apparatus of clause 38, wherein:
   the lift propeller comprises a four-bladed propeller, and
   the first reference axis comprises the line bisecting two longitudinal axes of two blades of the lift propeller.
41. The lift apparatus of clause 40, wherein two blades of the lift propeller comprise two adjacent blades of the lift propeller.
42. The lift apparatus of any of clauses 38 to 41, wherein the angle is from 2 to 10 degrees.
43. The lift apparatus of any of clauses 38 to 42, wherein the angle is from 4 to 10 degrees.
44. A vertical takeoff and landing (VTOL) aircraft, comprising the lift apparatus of any of clauses 38 to 43.
45. A method of operating a vertical takeoff and landing (VTOL) aircraft, comprising:
   while operating the VTOL aircraft in a cruise configuration, stowing the lift propeller by positioning a reference axis of the lift propeller at an angle with respect to a longitudinal axis of a fuselage of the VTOL aircraft;
   wherein the reference axis comprises one of a longitudinal axis of a blade of the lift propeller or a line bisecting two longitudinal axes of two blades of the lift propeller; and
wherein the angle is from 2 to 20 degrees.
46. The method of clause 45, wherein:
   the lift propeller comprises a two-bladed propeller, and
   the reference axis comprises the longitudinal axis of the blade of the lift propeller.
47. The method of clause 45, wherein:
   the lift propeller comprises a four-bladed propeller, and
   the reference axis comprises the line bisecting two longitudinal axes of two blades of the lift propeller.
48. The method of clause 47, wherein two blades of the lift propeller comprise two adjacent blades of the lift propeller.
49. The method of any of clause 45 to 48, wherein the angle is from 2 to 10 degrees.
50. The method of any of clause 45 to 49, wherein the angle is from 4 to 10 degrees.
51. The method of any of clause 45 to 49, further comprising:
   rotating the lift propeller to provide lift in the lift configuration; and
   transitioning to the cruise configuration.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the inventions disclosed herein.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Also, words such as “be” or “is” or “are” may refer to “include” or “includes” unless specifically directed otherwise. As used herein, unless specifically stated otherwise, being “based on” may include being dependent on, being interdependent with, being derived from (e.g., using), being associated with, being defined at least in part by, being influenced by, occurring upon, occurring after, and/or being responsive to. As used herein, “related to” may include being inclusive of, being expressed by, being indicated by, or being based on. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

Other embodiments will be apparent to those skilled in the art from consideration of the specification and practice of the implementations disclosed herein. It is intended that the architectures and circuit arrangements shown in figures are only for illustrative purposes and are not intended to be limited to the specific arrangements and circuit arrangements as described and shown in the figures. It is also intended that the specification and examples be considered as exemplary only, with the true scope and spirit of the invention being indicated by the following claims. The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the inventions disclosed herein. It is also intended that the sequence of steps shown in figures is only for illustrative purposes and is not intended to be limited to any particular sequence of steps. Moreover, steps may be combined from multiple different figures into a single embodiment. As such, those skilled in the art can appreciate that these steps can be performed in a different order while implementing the same method.

1. A lift apparatus for a vertical takeoff and landing (VTOL) aircraft, comprising:
a lift propeller comprising a first blade, a second blade, a third blade, and a fourth blade; and
a hub joining the first blade, the second blade, the third blade, and the fourth blade to form a continuous surface contour;
wherein:
the first blade is adjacent to the second blade and to the third blade; and
a first stagger angle between the first blade and the second blade is less than a second stagger angle between the first blade and the third blade.

2. The lift apparatus of claim 1, wherein the first stagger angle is from 65 to 85 degrees.

3. The lift apparatus of claim 1, wherein the second stagger angle is from 95 to 115 degrees.

4. The lift apparatus of claim 1, wherein the first stagger angle is from 70 to 85 degrees.

5. The lift apparatus of claim 1, wherein the second stagger angle is from 95 to 110 degrees.

6. The lift apparatus of claim 1, wherein the first stagger angle is from 74 to 83 degrees.

7. The lift apparatus of claim 1, wherein the second stagger angle is from 97 to 106 degrees.

8. The lift apparatus of claim 1, wherein a sum of the first stagger angle and the second stagger angle is 180 degrees.

9. The lift apparatus of claim 1, wherein a third stagger angle between the third blade and the fourth blade is equal to the first stagger angle.

10. The lift apparatus of claim 1, wherein a fourth stagger angle between the second blade and the fourth blade is equal to the second stagger angle.

11-12. (canceled)

13. The lift apparatus of claim 1, wherein an elbow contour leading from the first blade to the third blade comprises a saddle point at the hub.

14. The lift apparatus of claim 1, wherein:
the saddle point lies on a first cross sectional plane of the hub; and
an angle between the first blade and the first cross sectional plane is between 40% and 60% of the second stagger angle.

15. The lift apparatus of claim 1, wherein:
the hub comprises a first shape in a first cross sectional plane of the hub, the first cross sectional plane extending between the first blade and the third blade; and
the hub comprises a second shape in a second cross sectional plane of the hub, the second cross sectional plane extending between the first blade and the second blade.

16. The lift apparatus of claim 15, wherein a first length of the first shape in a rotational plane of the lift propeller is shorter than a second length of the second shape in the rotational plane of the lift propeller.

17. The lift apparatus of claim 1, wherein:
a maximum height of the hub is equal to or below a maximum height of the first blade by more than 5% of a radius of the first blade.

18. The lift apparatus of claim 1, wherein:
a maximum height of the hub is equal to or below a maximum height of a tip of the first blade by more than 5% of a radius of the first blade,
wherein the tip comprises a portion of the first blade between 90% and 100% of the radius of the first blade.

19. The lift apparatus of claim 1, wherein:
a maximum height of the hub is equal to or below a maximum height of the first blade by more than 2% of a radius of the first blade.

20. The lift apparatus of claim 1, wherein:
a maximum height of the hub is not above a maximum height of a tip of the first blade by more than 2% of a radius of the first blade,
wherein the tip comprises a portion of the first blade between 90% and 100% of the radius of the first blade.

21. The lift apparatus of claim 1, wherein:
a maximum height of the hub is less a height of a first point on the first blade; and
a maximum height of the hub is greater than a height of a tip of the first blade,
wherein the tip comprises a portion of the first blade between 90% and 100% of a radius of the first blade.

22. A vertical takeoff and landing (VTOL) aircraft, comprising the lift apparatus of claim 1.

23-37. (canceled)

38. A lift apparatus for a vertical takeoff and landing (VTOL) aircraft, comprising:
a lift propeller;
an engine configured to rotate the lift propeller;
a controller configured to control the engine while operating the VTOL aircraft in forward flight in a cruise configuration to position a first reference axis of the lift propeller at an angle with respect to a second reference axis of the VTOL aircraft in a cruise configuration; and
a support structure configured to support the engine and the lift propeller,
wherein:
the first reference axis comprises one of a longitudinal axis of a blade of the lift propeller or a line bisecting two longitudinal axes of two blades of the lift propeller;
the second reference axis comprises one of a longitudinal axis of the support structure or a longitudinal axis of a fuselage of the VTOL aircraft; and
the angle is from 2 to 20 degrees.

39. The lift apparatus of claim 38, wherein:
the lift propeller comprises a two-bladed propeller, and
the first reference axis comprises the longitudinal axis of the blade of the lift propeller.

40. The lift apparatus of claim 38, wherein:
the lift propeller comprises a four-bladed propeller, and
the first reference axis comprises the line bisecting two longitudinal axes of two blades of the lift propeller.

41. The lift apparatus of claim 40, wherein two blades of the lift propeller comprise two adjacent blades of the lift propeller.

42. The lift apparatus of claim 38, wherein the angle is from 2 to 10 degrees.

43. The lift apparatus of claim 38, wherein the angle is from 4 to 10 degrees.

44. A vertical takeoff and landing (VTOL) aircraft, comprising the lift apparatus of claim 38.

45-51. (canceled)
